(19) United States
(12) Patent Application Publication
(10) Pub. No.: US 2019/0057397 A1
(43) Pub. Date: Feb. 21, 2019

(54) Method and System for Issuing, Managing, Verifying and Displaying Digital Badges

(71) Applicant: BadgeCert, Inc., Northbrook, IL (US)

(72) Inventors: Ginger G. Malin, Northbrook, IL (US); Jay Ira Malin, Northbrook, IL (US); Raed Adhami, Hawthorn Woods, IL (US)

(73) Assignee: BadgeCert, Inc., Northbrook, IL (US)

(21) Appl. No.: 16/113,597

(22) Filed: Aug. 27, 2018

Related U.S. Application Data
(62) Division of application No. 14/283,189, filed on May 20, 2014.
(60) Provisional application No. 61/956,104, filed on Jun. 3, 2013.
(60) Provisional application No. 61/958,501, filed on Jul. 30, 2013.

(51) Int. Cl. G06Q 30/00; G06K 19/06

(52) U.S. Cl. CPC G06Q 30/018; G06K 19/06037

(57) ABSTRACT

A method is described herein for displaying digital badge information. The badge is a digital image being presented to a user of a computer application and associated with an individual or entity badge owner to whom the badge is issued. The method involves displaying the digital image to the user, receiving input indicating that the user has selected the digital image, and obtaining, from a data repository, information pertaining to the image and particular to an accomplishment of the badge owner. The method also further involves displaying at least a subset of the obtained information on an overlay to the image.

### CROSS-REFERENCE TO RELATED APPLICATIONS

This application claims the benefit of U.S. Provisional Application No. 61/956,104, filed May 20, 2013, by inventors Jay I. Malin and Ginger G. Malin, and U.S. Provisional Application No. 61/958,501, filed Jul. 26, 2013, by inventors Jay I. Malin and Ginger G. Malin. The contents of these provisional applications are incorporated by reference for all that they disclose.

### FIELD

The invention relates to a platform for verification and registration of digital recognition indicia such as digital certificates.

### BACKGROUND

In order to be successful, an organization requires a large number of individuals to each perform component actions that advance the goals of the organization. In order to be successful in accomplishing actions assigned by an organization, an individual must often posses certain proficiencies. If an organization is to reach the goals its constituents have set for it, the tasks that must be performed must be assigned to individuals who are capable of accomplishing them.

Unfortunately, it is often costly for decision-makers in an organization to ascertain the proficiencies possessed by each of its members. However, credentials earned by an individual provide information regarding that individual's proficiency level at some task or another. Additional information can be gleaned in situations where the credential is provided by an entity trusted by the organizational decision makers. Organizations both large and small rely heavily on the information credentials and the source of those credentials provide in order to efficiently allocate human resources.

### SUMMARY

A system and method for displaying digital badge information are described herein, the badge corresponding to a digital image being presented to a user of a computer application and associated with an individual or entity badge owner to whom the badge is issued, the method comprising displaying the digital image to the user, receiving input indicating that the user has selected the digital image, obtaining, from a data repository, information pertaining to the image and particular to an accomplishment of the badge owner, and displaying at least a subset of the obtained information on an overlay to the image.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 depicts an example system architecture in which issuers provide digital badges to earners through the infrastrurcture provided by a cloud-based digital badge management and verification platform;

FIG. 2 is a flow diagram that illustrates an example process for creation and issuance of digital badges shows a complete flow diagram;

FIG. 3 is a flow diagram that illustrates an example process for sharing, displaying, and endorsing digital badges.

FIG. 4 is a flow chart outlining a process by which an employer, or an employer's representative, can create badges and issue the badges to its employees.

FIG. 5 depicts an example graphical user interface at the website of the digital badge management and verification platform for managing an employee roster and issuing digital badges.

FIG. 6 depicts an example digital badge display webpage;

FIG. 7 depicts an example digital badge and a graphical element for digital badge metadata display.

FIG. 8 depicts an example digital badge design graphical user interface that can be used to create a digital badge;

FIG. 9 depicts an example badge issuance graphical user interface through which an issuer can issue a digital badge;

FIG. 10 depicts an example template based email for delivery to an earner upon badge issuance;

FIG. 11 depicts an example graphical user interface for creation of self-reported digital badges;

FIG. 12 is a flow chart outlining an example process for creating and issuing badges;

FIG. 13 depicts an example custom badge issuance graphical user interface;

FIG. 14 depicts an example badge earner profile webpage;

FIG. 15 depicts an example badge earner profile webpage in which a pending badge dropdown graphical user interface element is depicted;

FIG. 16 depicts an example badge management graphical user interface component of a badge earner website;

FIG. 17 depicts a set of example digital certification badges having different appearances that corresponding to the different circumstances surrounding their issuance

FIG. 18 depicts an example email template for an email in which a key that provides one-time access to a webpage at which a badge is displayed is delivered.

FIG. 19 depicts an example digital badge display webpage providing access only through a privacy key;

FIG. 20 depicts an example user interface supporting entry of endorser identification and contact information;

FIG. 21 depicts such an example automated email message configured to be delivered to a prospective endorser of a digital badge

FIG. 22 depicts an example badge endorsement information entry interface at such a web portal landing page;

FIG. 23 is a flow chart outlining an example process for issuing a digital badge and acquiring an endorsement of the digital badge from an authorized endorser; and

FIG. 24 depicts an example point earner leaderboard component of a webpage.

### DETAILED DESCRIPTION OF THE DRAWINGS

The invention contemplates digital badge management and verification platforms that may act to register and verify digital badges. A “badge” can refer to any certificate (e.g. as awarded for a measure of proficiency related to knowledge and skill building) or to recognition of an accomplishment (e.g. professional development training, continuing education experiences, professional certifications, endorsements, and academic degrees). A badge can include an image embedded with metadata and can be, in various implementations, associated with an issuing organization, with metrics by which the badge was earned, and with details as to how the earner completed the metrics. Systems and methods disclosed herein may provide technical tools needed for organizations to issue certified badges and allow individual users the ability to register and store their certified badges in a digital portfolio (e.g. a grouping of an individual earner's badges) to access, share and display such badges on resumes, online job applications, social media outlets (e.g. Facebook® or Linkedin®), personal websites, and any other digital formats they wish to. The systems and methods disclosed herein may also provide users the ability to record and store their uncertified experiences and the metadata associated with them to create a generic badge to share with educational institutions and current and prospective clients and employers, non-exclusively.

Today, learning happens in many different environments and contexts, but is often not recognized or legitimized unless it is done within a formal school setting. Moreover, when learners participate in an informal learning experience such as a conference, professional development training program, or an online course that advances their knowledge and skills, they have no way of verifying their participation, validating the program's integrity and ability to meet objectives, digitally sharing their accomplishment, or having it recognized by employers, colleagues or others as a meaningful and relevant learning experience. To recognize, legitimize, and professionalize the informal learning that takes place both online and in informal settings, a system is established to verify, validate and store the information and data related to the learning, thus rendering a badge as “certified.”

The digital badge management and verification platforms described herein have data structure components that may include but are not limited to badge issuers, users, and badges. Badges can be issued automatically via an application programming interface (API), via a certified badge issuing organization on a certification badge platform website, and via self-reporting on a certification badge platform website.

In addition, many people claim to have participated in formal training programs that cannot be adequately verified. With digital badge management and verification platforms described herein, potential employers can rely on the information that an employee shares because it is independently verified and registered on a hosted, secure site. This includes such learning experiences as: earned academic degrees, continuing education credits, passed exams, and other achievements or experiences.

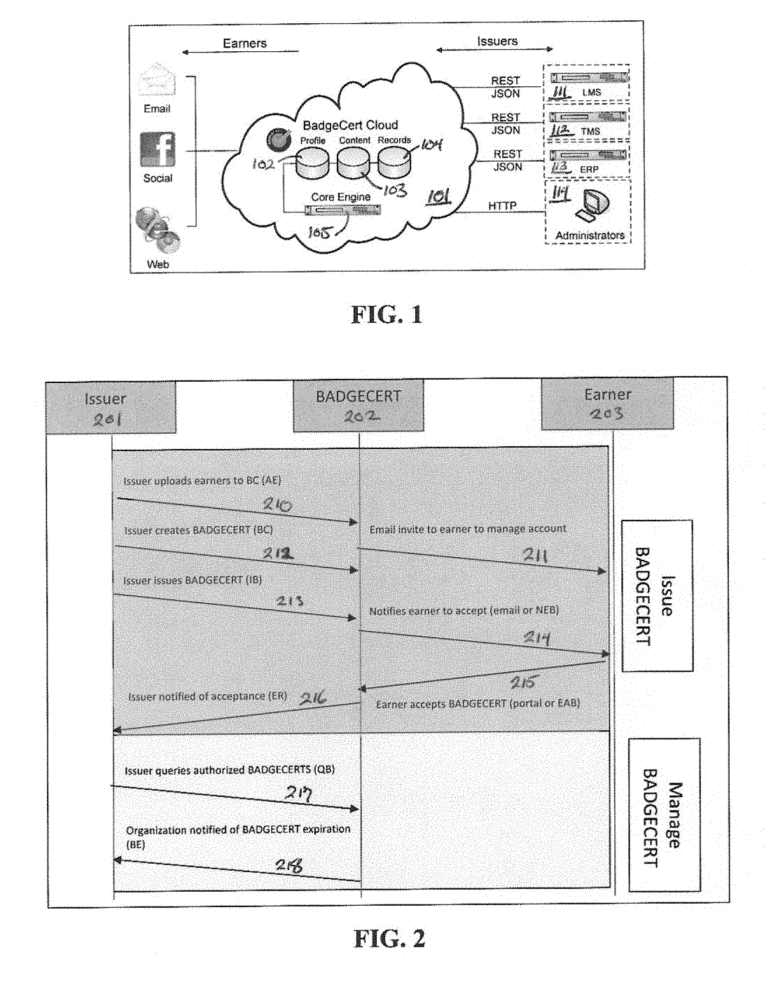

FIG. 1 depicts an example system architecture in which issuers provide digital badges to earners through the infrastrurcture provided by a cloud-based digital badge management and verification platform. FIG. 1 depicts a cloud-based digital badge management and verification platform communicatively connected to a plurality of digital badge issuers and to a plurality of web based applications. Specifically, the cloud-based digital badge management and verification platform is the BadgeCert badge management cloud 101. The BadgeCert badge management cloud comprises computer readable storage media at which various profile data, content data, and records data can be stored. In the system architecture of FIG. 1, the BadgeCert badge management cloud includes a profile database 102, a content database 103, and a records database 104. The Badgecert badge management cloud additionally includes a core engine 105. The core engine 105 includes one or more processors that, in various implementations, can be remotely located from one another but in communicative connection with one another or may be co-located at the same place. The processors of the core engine 105 are configured to execute computer readable instructions stored at non-transitory computer readable media co-located with the core engine 105.

The system architecture depicted in FIG. 1 further comprises learning management system (LMS) 111, talent management system (TMS) 112, enterprise resource planning system (ERP) 113, and an administrators group 114. LMS 111, TMS 112, and ERP 113 are connected to the BadgeCert badge management cloud 101 through REST-JSON interfaces, and the administrators are connected to the BadgeCert badge management cloud 101 through an HTTP interface. The BadgeCert badge management cloud 101 is additionally connected to badge earners through a variety of web-based applications including email and social networks.

A digital badge management and verification platform according to an embodiment of the invention serves as an unbiased registrar and verifier of digital badges. A digital badge may refer to any digital certificate (measure of proficiency related to knowledge and skill building), or recognition of accomplishment including professional development training, continuing education experiences, professional certifications, endorsements, and academic degrees. A digital badge can be an image embedded with metadata associated with the issuing organization, accomplishments required to earn the digital badge, and identification assigned to the earner. The digital badge software management platform delivers the technical tools required for verified organizations to issue digital badges and allows individual earners to accept and store their digital badges in the form of a digital portfolio (e.g. a grouping of badges belonging to individual earner) to access, share and display them on resumes, online job applications, social media outlets (e.g. Facebook® or LinkedIn®), personal websites, and any other digital formats they wish.

A badge issuing organization is certified by supplying validating information to the certification badge platform via the web or API. The organization is issued an organization number and a status, such as “pending.” When a new organization requests certification, an email is sent to system administrators. An individual may also self-report badges on a client or the certification badge platform website and will be added in the optional field, badgerecID. Table 1 provides a number of example parameters maintained by a digital badge management and verification platform for the classification of and interaction with a badge issuing organization.

TABLE 1

| Field | Purpose |
|---|---|
| orgID | Badge issuing organization ID |
| requDate | Date/time badge issuer requesting certification |
| certDate | Date/time badge issuer certification issued |
| orgWeb | Organization website |
| orgBus | SIC code for organization |
| orgDB | Organization D&B number |
| orgAddress | Organization address |
| orgPC | Organization primary contact (correlates to adminID in |
| | Table 2) |

Table 2 provides an example list of users holding administrative positions with the badge issuing organization.

TABLE 2

| Field | Purpose |
|---|---|
| adminID | User in badge issuing organization |
| orgID | Badge issuing organization ID per Table 1 |
| username | Admin Username |
| password | Admin Password |
| timezone | Primary organization time zone |
| roleID | Role for administrative user per Table 3 |
| Name | Admin name (first, MI, last) |
| Address | Admin address (street, city, state, ZIP, country) |
| email | Admin email address |
| Mobile phone | Admin mobile phone number |
| Landline | Admin voice/landline number |

Table 3 provides permissions allocated to users of the badge management and verification platform as defined by role or position within the organization.

TABLE 3

| Field | Purpose |
|---|---|
| roleID | Administrative user roleID |
| roleTitle | Role title such as IT admin, HR Manager, HR admin |
| adminUser | READ, EDIT, DELETE admin users |
| createBadge | READ, EDIT, DELETE badges |
| issueBadge | WRITE badges (note: badges cannot be removed upon |
| | creation) |
| createEarner | READ, EDIT, DELETE badge earner (doesn't remove |
| | earner from BC/just from an organization's view) |
| adminOrg | READ, EDIT, DELETE organizations |

Table 4 provides example parameters maintained by a digital badge management and verification platform for the classification of and interaction with a badge earner.

TABLE 4

| Field | Purpose |
|---|---|
| earnerID | Badge earner ID |
| email(1 . . . x) | Badge earner email and username (note: a badge earner |
| | may have several email addresses associated with his/her |
| | account) |
| password | Badge earner password (created by earner) |
| timezone | Timezone for badge earner |
| Name | Earner name (first, MI, last) |
| Address | Earner address (street, city, state, ZIP, country) |
| Mobile phone | Earner mobile phone number |
| Landline | Earner voice/landline number |

An organization may wish to upload a roster of its employees or students. In some implementations, doing so requires the organization provide an email address for each roster entry to the badge management and verification platform, which send a message to each earner requesting validation of the email address and the information specified in Table 4. If the earner has multiple email addresses, badge management and verification platform can link them to the same earner profile.

Table 5 provides an association between earners and organizations.

TABLE 5

| Field | Purpose |
|---|---|
| orgID | Organization ID |
| earnerID | Earner ID |
| siteID | Site ID within organization to which earner belongs |
| | (edited only by organization) |
| departmentID | Department ID within organization to which earner |
| | belongs (edited only by organization) |
| groupID(1 . . . x) | Group ID within organization to which earner belongs |
| | (edited only by organization). The administrator may |
| | create multiple groups to which an earner is associated |
| earnerName | Earner name (first, MI, last) as specified by issuer |
| | (employee may specify another name in his/her pro- |
| | file), (edited only by organization) |
| EmployeeID | Employee or contractor ID number for internal pur- |
| | poses (edited only by organization) |

A Badge can be a PNG image associated with badge attribute metadata as described in Table 6. A badge is issued by an issuing organization, although the issuing organization may be the earner as is the case with a self-reported badge.

TABLE 6

| Field | Purpose |
|---|---|
| badgeID | Badge ID |
| issueorgID | Badge issuing organization ID |
| badgeType | Verified organization or self-issue |
| badgeGenre | Examples include conference, online course, |
| | classroom |
| earnerID | Optional earner ID only if badge self-issue |
| gamePoints | Optional value of badge for purpose of intro- |
| | ducing gamification (not available for self-issue |
| | badges) |
| imageID | File location of PNG image associated with the |
| | badge |
| createDate | Date/time badge created |
| certdate | Date badge certified (optional) |
| Badgeshortdescription | Short descriptive text on badge |
| Badgelongdescription | Long descriptive text on badge |
| metricData | XML data associated with requirements to earn a |
| | badge |

The metricData field encapsulates the criteria required to earn the badge and other measurable objectives. Example XML data of a metricData field is provided immediately below:

<metricData>

<badgeID>148</badgeID>

<duration>40 hours</duration>
<cost>$1500</cost>
<objective>Able to successfully demonstrate removal and installation
of a new Toyota radiator.
</objective>
<measure>Instructor observation</measure>

<location>
<Latitude>34.6943911111111</Latitude>
<Longitude>−86.726585</Longitude>
<NearestAddress>275 Pineridge Rd, Madison, AL 35758,
USA</NearestAddress>

</location>

</metricData>

Parameters characterizing an earned badge are described in Table 7.

TABLE 7

| Field | Purpose |
|---|---|
| earnerID | Earner ID |
| badgeID | Badge ID |
| badgeTitle | Badge Title (or name) |
| pointOver | Optional: adjustment to gamePoint on a per earned badge |
| | basis. This an integer number of points beyond the assigned |
| | points in Table 6 |
| earneddate | Date badge earned |
| certfdate | Date badge earned certified (optional) |
| issueData | XML description of badge earned |

The issueData field is an XML, description of an earned badge. The following is an example of an issueData field:

<issueData>

<badgeID>148</badgeID>
<period>
<startDate>2011-05-06 11:28:57 EDT </startDate>
<endDate>2011-05-06 11:28:57 EDT </endDate>

</period>
<reflection>No reflection provided</reflection>
<evaluation>Affirmed by Instructor #23142</evaluation>
<media>

<artifact2>http://location.jpeg </artifact1>
< artifact2>http://location.jpeg </artifact2>

</media>

<Location>Mobile confirmed</Location>

</issueData>

FIG. 2 is a flow diagram that illustrates an example process for creation and issuance of digital badges shows a complete flow diagram. FIG. 2 depicts an Issuer 201, the BadgeCert digital badge management and verification platform 202, and an Earner 203. At 210, the Issuer 201 uploads earners to BadgeCert 202 via an Add Earner (AE) API call flow. At 211, the BadgeCert digital badge management and verification platform 202 sends an email to the Earner 203 inviting the Earner 203 to manage a digital badge earner account. At 212, the Issuer 201 creates a BADGECERT digital badge via a CreateBADGECERT (CB) API call flow. At 213, the Issuer issues the BADGECERT through the IssueBADGECERT (IB) API call flow. At 214, the BadgeCert digital badge management and verification platform 202 sends an email to the Earner 203 notifying the earner of the unaccepted issued BADGECERT or notifies the Earner 203 via a Notify earner of new BADGECERT (NEB) API call flow. At 215, the Earner 203 accepts the digital badge via a standard Internet connection or through an Earner accept new BADGECERT (EAB) API call flow. At 216, the BadgeCert digital badge management and verification platform 202 notifies the Issuer 201 of acceptance via an Earner response (ER) API call flow. At 217, the Issuer queries the BadgeCert digital badge management and verification platform 202 for authorized BADGECERTS via a Query BADGECERT API call. At 218, the BadgeCert digital badge management and verification platform 202 notifies the Issuer of expiring BADGECERTS via a BADGECERT expiration (BE) API call.

In some implementations of the invention, prior to creating and issuing digital badges, a Client adds earners to the digital badge management software platform to create a roster of earners that can be issued digital badges and queried. A digital badge ID (badgeID) is created for many users and can be re-used for recurring events; however, after being created, an issued digital badge ID (issueID) pertains to one earner (earnerID) and one event. After successfully creating and issuing a digital badge, and upon earner acceptance of the digital badge, a Client may query digital badges and can be notified of expiring digital badges.

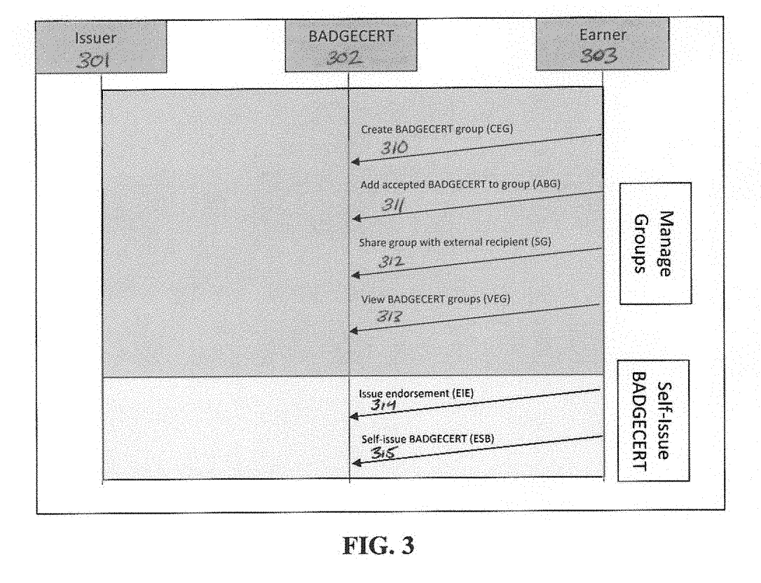

FIG. 3 is a flow diagram that illustrates an example process for sharing, displaying, and endorsing digital badges. FIG. 3 depicts an Issuer 201, the BadgeCert digital badge management and verification platform 302, and an Earner 303. At 310, the Earner 303 creates a badge group via a Create BADGECERT group (CEG) API. At 311 the Earner 303 adds an accepted BADGECERT to group via an Add accepted BADGECERT to group (ABG) API call. At 312, the Earner 303 creates a share group with external recipients of the badge via a Share group (SG) API call. At 313, the Earner 303 executes a view BADGECERT groups (VEG) API call. At 314, the Earner runs an Issue endorsement (EIE) API call. At 315, the Earner 303 executes a self-issue BADGECERT (ESB) API call.

Example digital badge management and verification platforms described herein can create groups and add digital badges to the groups. Furthermore, earners can share groups with external users and social networking applications. Other sharing channels may be available in the future, including enterprise applications.

The present application provides digital badge platforms that can, in various implementations, provide the technology for organizations to create badges for display on a website and issue badges from their information systems to users and thereby for users to collect and store the badges in their digital badge portfolios. The user's profile may be recalled using a predefined username such as an email address.

The present application further provides a plugin, iframe, or application programming interface (API) that can synchronize with a learning management system (LMS) or an issuing agency information system so as to create and issue badges.

Example digital badge management and verification platforms described herein can register and validate badges, can provide a rating system based on specified standards-based criteria, provide a customizable universal digital badge portfolio that can enable users to record, organize, manage, store, carry, and export their badges to resumes, online job applications, Facebook®, Linkedin®, other websites, and elsewhere, can provide a tool for employers or other learning agencies to verify users' badges (e.g. with a single use digital key), can provide technology for organizations to track contractors or employees' certifications to ensure up-to-date compliance and to maintain records regarding their employees' ongoing professional development.

Example digital badge management and verification platforms described herein can also provide a communications management platform the offers communication templates, per client and per badge, that allows an issuing organization to determine notification preferences for earners upon receiving an invitation to participate in a digital badge program, upon issuance of a digital badge, upon expiration of a digital badge, and upon sharing a badge via email with external recipients.

Example digital badge management and verification platforms described herein can offer a badge platform that is customized by issuing organizations such that the organization may define the metadata fields so that badge data may be industry specific. A customized badge can be either one or both of issued by an issuing organization and self-reported by an authorized earner. Such a badge may be called an “industry” or “skill” badge.

Example digital badge management and verification platforms described herein can allow earners to self-report digital badges, (which may be called skill badges) that can be endorsed by authorized 3rd parties. The earner may select from a list of authorized endorsers (within his/her industry or employer) and the endorser would acknowledge the earner's informational upload.

Example digital badge management and verification platforms described herein can further allow earners to provide feedback for continuing education courses, workshops, or training programs that is subject to dissemination to the training provider, public community, or certifying organizations partnered with the training provider, and can further include an analytics dashboard for tracking created badges, issued badges, badges accepted or opened by the recipient, and badges shared and clicked by viewers, regardless of whether the sharing or viewing is performed via social network, email, website, or career site.

Example digital badge management and verification platforms described herein provide for “leveling-up,” or for clustering badges. In such implementations, a sequence of badges may be created that, when issued in combination to a single earner, automatically entitle that earner to “level-up” to a new badge or certificate. The milestone badges may be retained or replaced by the new, more substantial badge. In this context, the term “Replaced” denotes, in various implementations, that they may (a) no longer be stored in the database and viewable by earners and viewers; and/or (b) remain in the database and no longer shareable by earners. The new badge could be shared with any parties for which the milestone badges were already shared.

A digital certification badge management platform described herein enables an employer to issue badges to its employees. An employer may issue badges for a variety of reasons which may include attendance at a conference, participation in training, participation in other desired behaviors (e.g. mentorship), or demonstration of particular competencies. The badge may be fairly standard such as “passed Tier 1 training,” and it may be created once and issued several times with additional metadata.

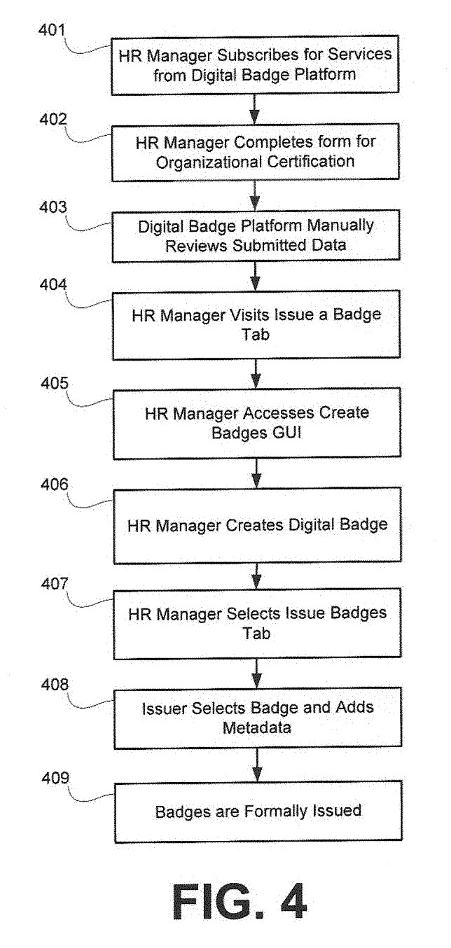

FIG. 4 is a flow chart outlining a process by which an employer, or an employer's representative, can create badges and issue the badges to its employees. At 401, an HR manager subscribes for services from the digital badge management and verification platform at a website of the digital certification badge management platform. At 402, the HR manager completes a form for organizational certification if the company wishes to issue badges. At 403, the certification badge platform manually reviews the submitted data and certifies company. An email alert is sent to the HR manager. In the event company fails verification, HR manager is afforded opportunity to submit requested data. At 404, upon acceptance of the employer, the HR Manager visits an “Issue a Badge” tab on the website of the digital badge management and verification platform.

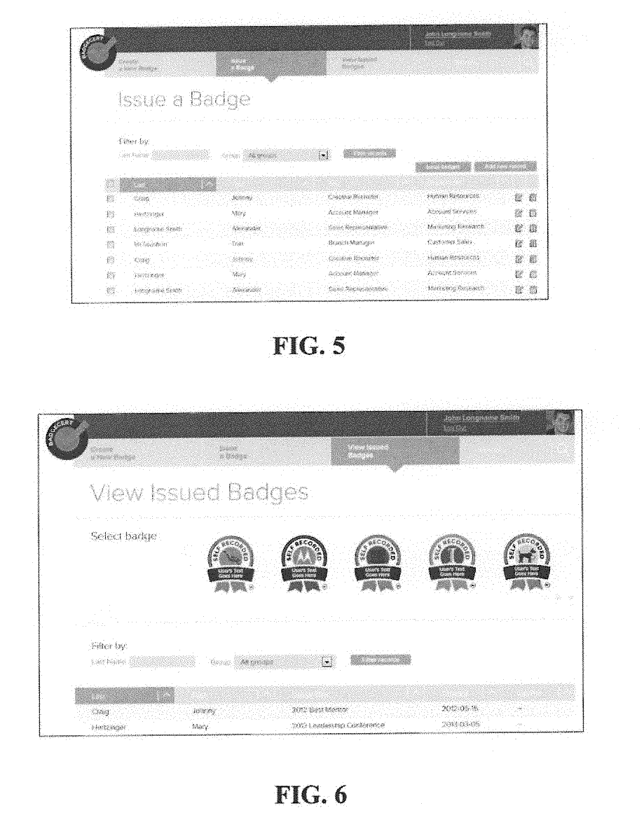

FIG. 5 depicts an example graphical user interface (GUI) at the website of the digital badge management and verification platform for managing an employee roster and issuing digital badges. The GUI includes tabs for employee name, department, type of badge, badge earned, and last update and expiration date/time. The Manager can click on any listing for more information or employee roster details. Manager has the ability to filter data by date/times, badge types, and employee departments. The Manager is able to select whether an expired badge would create an alert.

The HR manager can click on each employee to “View Badges” in tabular form as shown in FIG. 6, which depicts an example digital badge display webpage. The tabs include: employee name, department, type of badge, badge earned, and last update and expiration date/time. The HR manager can click on any listing for more information or employee roster details. The manager has the ability to filter data by date/times, badge types, and employee departments. The manager is able to select whether an expired badge would create an alert.

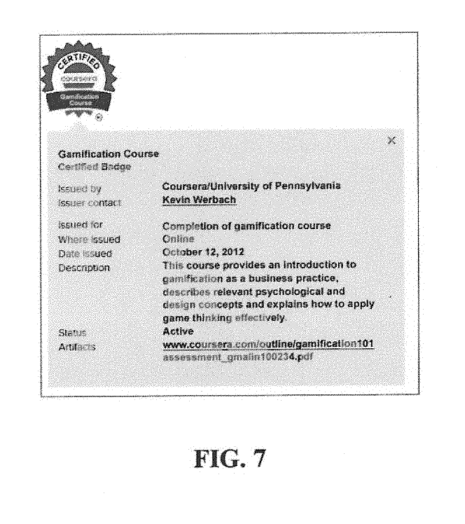

FIG. 7 depicts an example digital badge and a graphical element for digital badge metadata display. HR manager can click on any badge and will be provided metadata for the respective badge as shown in FIG. 7. Upon expiration of an employee's badge, an alert can be shown in the page and the Manager can suppress the alert.

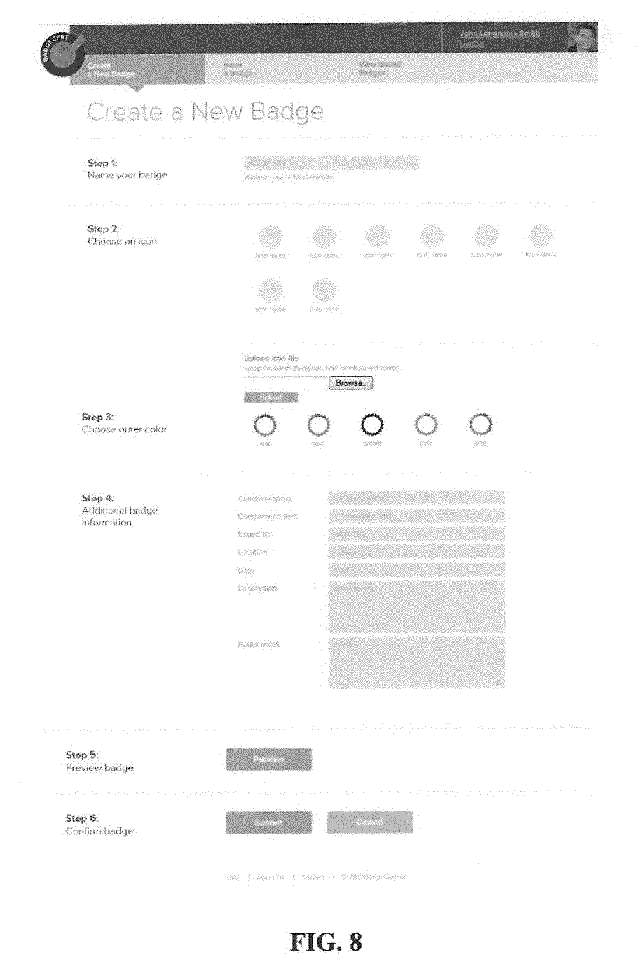

At 405 of FIG. 4, the HR manager accesses the website of the digital badge management and verification platform and interacts with the website to access a “Create badges” GUI. At 406 the HR manager creates a digital badge. FIG. 8 depicts an example digital badge design GUI that can be used to create a digital badge at 406. FIG. 8 can be accessed from a tab titled “create badges” at the certification badge platform website and displays a GUI that allows the user to select the graphics and form data for the badge. Additional data such as “Issue” vs. “Create” data may be added as part of the issuance process. The HR Manager is able to select the badge color, shape, and an icon, including custom artwork.

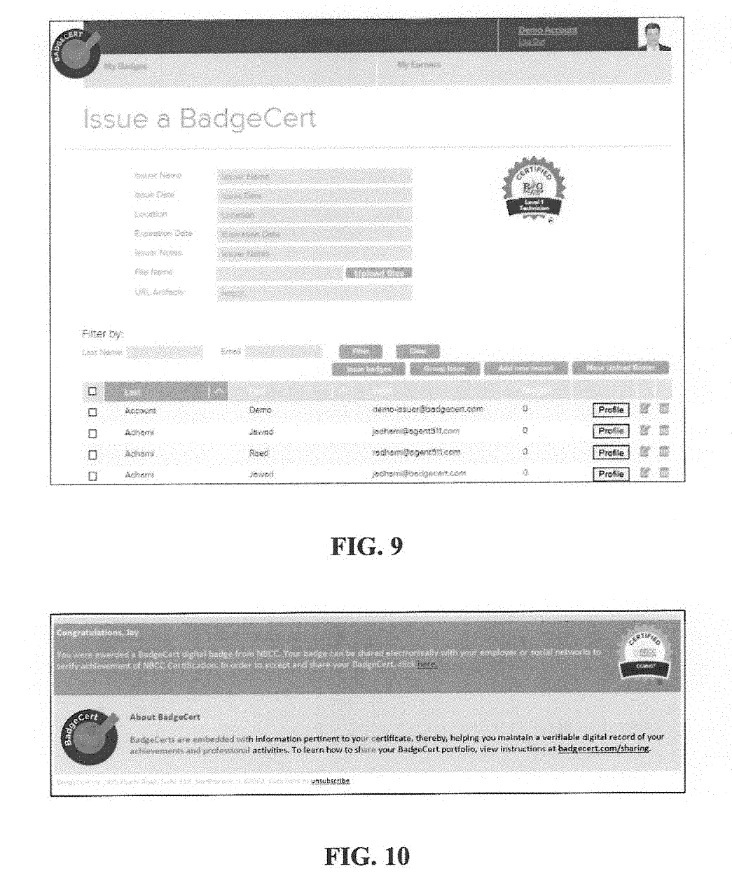

At 407, the HR manager visits the digital badge management website and selects the tab “issue badges.” FIG. 9 depicts an example badge issuance GUI through which the HR manager can issue a digital badge. The “issue badge” GUI offers several options: (1) manually issue badges to an employee on the roster by filtering and ticking his/her name; (2) upload an Excel spreadsheet list of employees to which a badge should be issued; and (3) review pending badges that were created by employees (e.g. mentorship). At 408, the issuer selects the badge (by graphic) and adds more metadata surrounding the specific accomplishment. This can be individual or group-based. Additional web features will be available that streamline the issuance process to individual earners. This is already available via the application programming interface (API) discussed below.

When all of the fields are completed and reviewed, badges are formally issued by the certification badge platform at 409. The earner will be issued an invitation to accept the badge into his/her portfolio. An issuer cannot retract a badge without submitting a formal request to digital badge platform operations. The earner invitation may be in the form of an email, such as that shown in FIG. 10, which depicts an example template based email for delivery to a badge earner upon badge issuance.

In alternative implementations to that described by FIG. 4, an organization may create its own custom metadata fields for the purpose of issuing a custom badge or permitting earners to self-record badges.

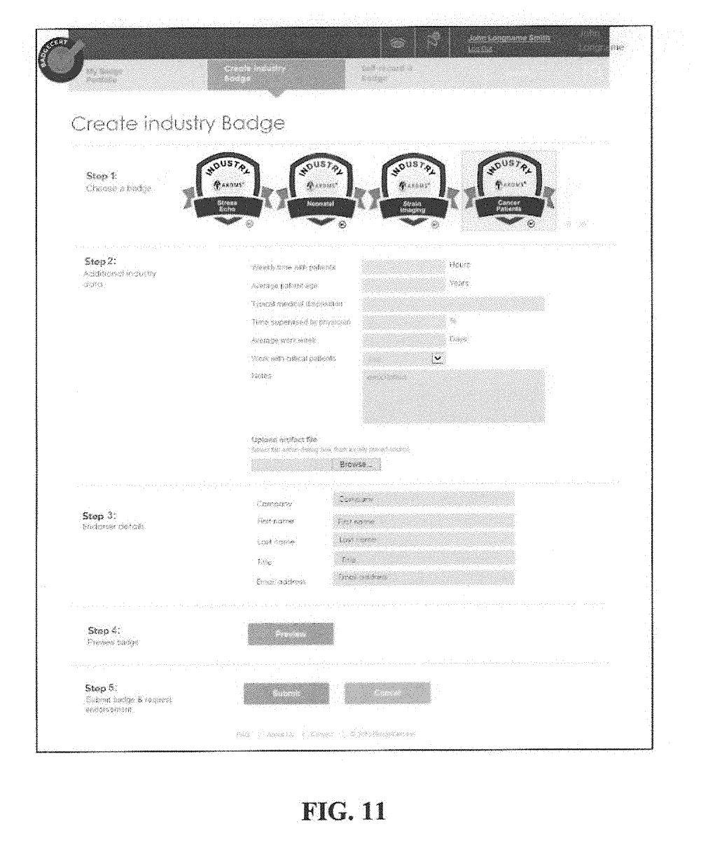

Implementations of example digital badge management and verification platforms are provided herein that provide an interface at which an individual can create a self issue badge that can be verified by his/her HR manager, HR department, or other appropriate personnel. An employee or contractor may be offered the ability to create a self-issue badge within the Company that is verified by his/her manager and HR. The employee would visit his/her account, and if offered by the employer, the employee is offered a tab “self-issue.” The employee visits the tab and can issue a badge using various information. This information may be customized by the issuing organization such as an association wishing to collect data pertinent to the industry. These fields may be pull-downs, radio buttons, memo style, or formatted such as date, time, or alike. The sample badge for the earner to submit these details is shown in FIG. 11, which depicts an example graphical user interface for creation of self-reported industry badges.

The GUI of FIG. 11 further allows an employee to select a pull-down window with authorized supervisors who are requested to verify the badge. In such implementations, the system provides for the supervisor to be notified of the badge request via email and to be offered a button to verify the badge in the email. He/she is queried for a password. Upon verification, the badge is pending and the HR manager is alerted in the certification badge system that he/she needs to validate the badge. Upon validation it is issued. It can be denied or remain pending—until then it is not issued to the earner.

A certification badge platform is provided herein that allows an organization that delivers training to issue badges, e.g. upon successful completion of a course—whether delivered live or on-line. The training company would undergo a similar account creation and certification process as that which the employer was required to for registration with the digital badge management and verification platform. The badge issue process would also be similar to any corporate HR department, except for the employee dashboard. The training company can manually issue badges nearly identically. A badge may be issued manually via web portal, through an API call from a learning management system (LMS), or via a unique certificate check-in system.

If an API call is made to issue the badge via LMS, the LMS provider acquires an API key from the certification badge platform to automatically issue badges. This API may be similar to the corporate HR API. This key may be acquired on-line or via account manager. When the user logs into the LMS, he/she would provide the applicable email address for his/her portfolio. He/she may also be directed to enter a company code that will alert his/her employer that the training is completed. This code may also authorize him/her to use the LMS module. When the user completes his/her training, the LMS system will make an API call to the certification badge platform to issue the badge. Fields include the key, badge earner email address, company code, badge creation and expiration date/time, badge type, training criteria (metadata), and evidence of completion. Other fields may be considered. The earner will be invited to accept the badge which upon acceptance will appear in the badge earner's portfolio and can be shared with the company. If authorized, the company is able to specify when the badge can be shared with others.

The certifying organization would construct a series of branded and co-branded digital badges, which upon issuance by a partner training provider would demonstrate competence towards achievement and renewal of certificates. The certifying organization would provision and onboard its web platform for each CE partner provider. Each provider would be able to issue digital badges to the certifying organization's certificate holders commensurate with training programs authorized by the organization. Upon issuances of the badge, the earner would be able to view and share the accomplishment—in part a milestone towards certification and/or renewal—and the badge is archived and delivered to the certifying organization.

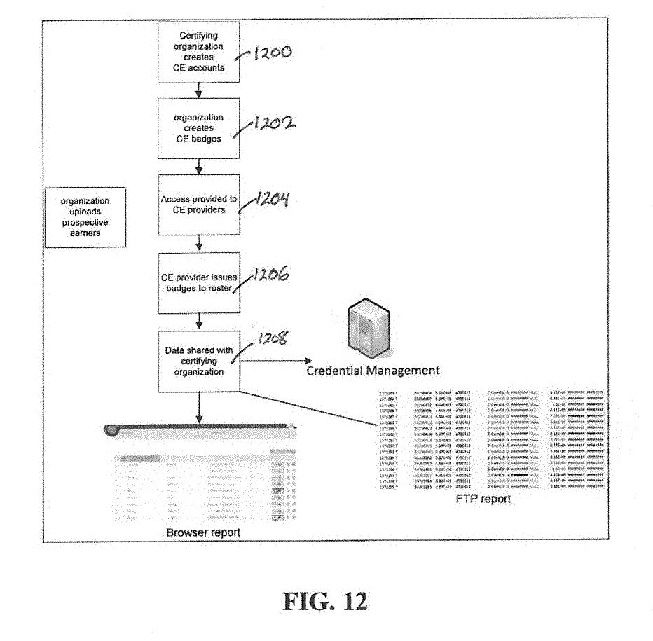

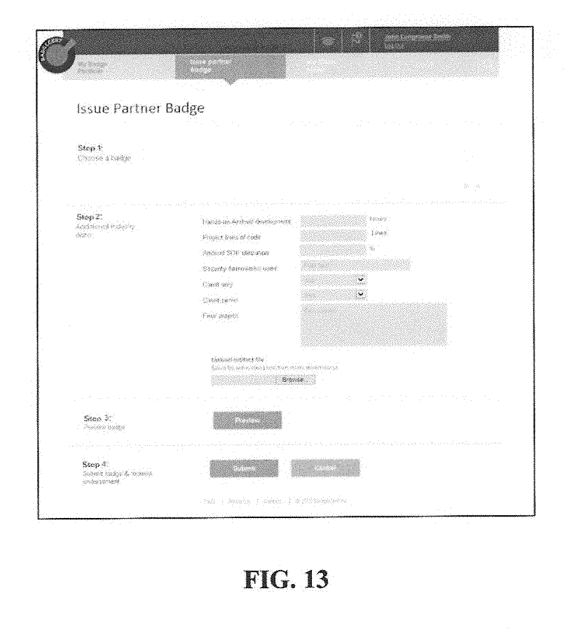

A sample view of the partner process for issuing customized and co-branded badges is shown in FIG. 12. At 1200 a certifying organization creates CE accounts. At 1202 the organization creates CE badges. At 1204, the access is provided to CE providers. At 1206, the CE provider issues badges to the roster. At 1208, data is shared with the certifying organization. The badge issuance process is shown in FIG. 13.

Digital badge management and verification platforms described herein provide a certification badge platform that renders an earner eligible to receive a badge upon presenting a unique identifying code. Upon presentment of a unique identifying code, such as a bar code or QR code by an earner, the earner would be added to the CE course roster and eligible for issuance of a digital badge by the training provider. The QR code would be provided to the earners by the certifying organization and would be specific to each earner. When the QR code is scanned by the training provider, either an SMS with an identifying code inside the QR code is submitted to a recipient (phone number or short code) and the earner is registered and/or verified to have taken the course. Alternatively, the code may invoke a unique URL which performs a similar function. The value of the SMS is the trainer's phone number is recorded—and handset location if authorized, for the purpose of verifying the trainer and earner.

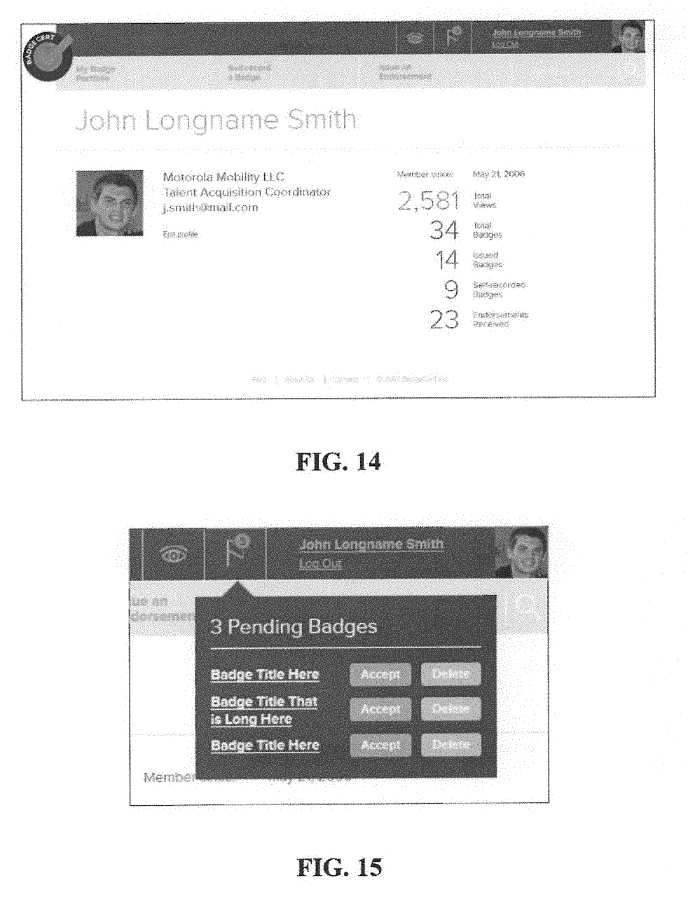

Digital badge management and verification platforms are described herein that allow a badge earner to create an account at a webpage provided by the digital badge management and verification platform. In order to create an account, a user provides various information which may include an email address, a user name, a password, badge privacy settings, and one or more badge portfolio groups. Once an account has been established, a user account webpage, such as that depicted in FIG. 14, provides GUI widgets that allow the user to enter commands to accept badges, manage badges, view badges, group badges, and self-issue badges. FIG. 15 depicts an example badge earner profile webpage that includes a graphical user interface comprising a notification tab that shows whether or not there are invitations to accept badges. The user may elect to accept or delete the invitations to accept the pending badges. If the user makes a decision to either accept or delete the badge, some implementations contemplate for automatically notifying the issuer that an issued badge was either accepted or declined. the issuer's digital badge management and verification platform

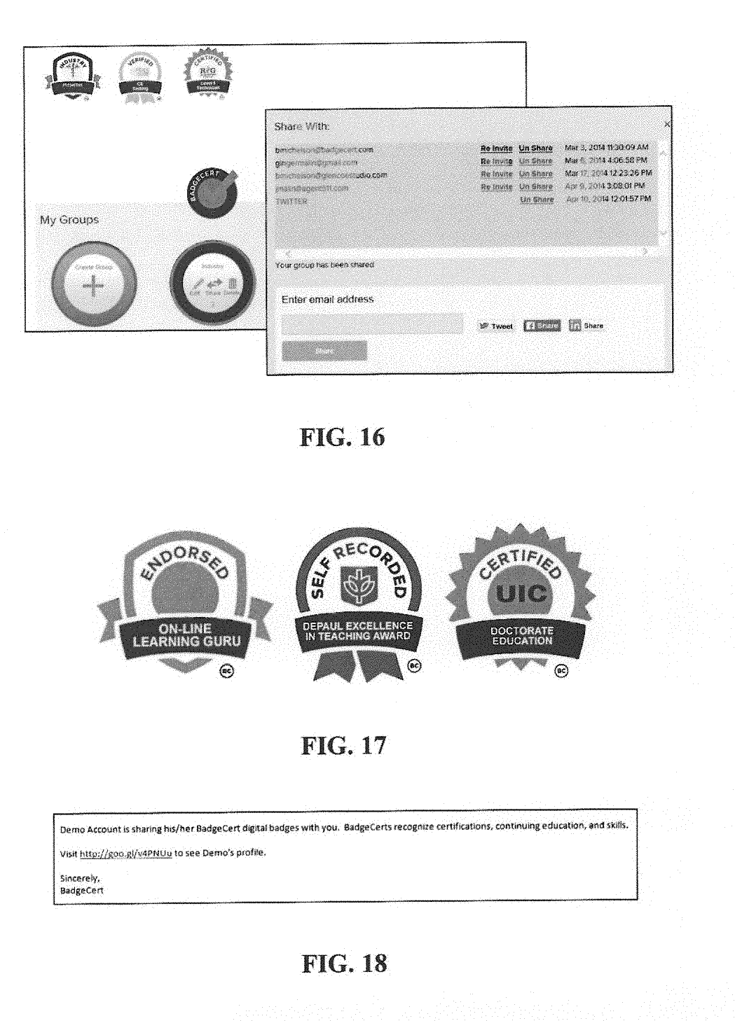

FIG. 16 depicts an example badge management graphical user interface (GUI) component of a badge earner account website and includes options for grouping and privacy. The GUI provides the option for a user to move badges into defined groups, to modify the names of the groups into which badges can be moved, to view received badges and to determine how frequently his/her received badges have been viewed by others. As an example, the earner may have a group called “Software,” or when up to two group levels are available, e.g. a user may create a sub-group called “Java.” Likewise, the user can create a group, called “Texas Instruments” and another called “Intel” corresponding to his employers. The user can “View Badges” and drag and drop badges into groups. A group can also have privacy settings as can individual badges. An earners privacy settings are lower than a badge issuer; namely, an employer can always see badges issued by the company (or on behalf of the company—e.g. a training firm). In addition, if the earner provides a viewer a privacy key (e.g. website URL) to view his/her badges, the earner can see how many times his/her badges are viewed.

Embodiments of the invention further provide a graphical user interface through which a badge earner may self-issue badges. The process by which a badge earner may self-issue a badge is similar to the employed by corporate earners, except the process whereby the self-issued badge is verified by a superior, such as a manager or supervisor, is absent.

In some implementations, badges may be categorized according to circumstances surrounding their issuance. FIG. 17 depicts a set of example digital certification badges having different appearances that corresponding to the different circumstances surrounding their issuance.

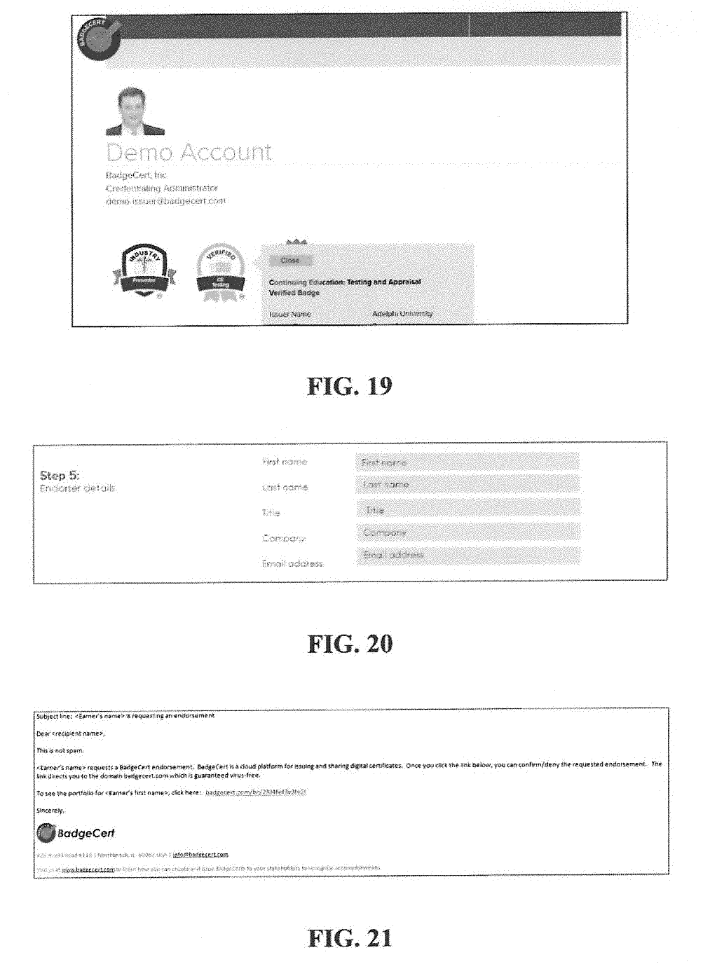

Embodiments of the invention provide a digital badge management and verification platform that allows a badge earner to create a privacy group for a specific “badge viewer,” such as a hiring manager. As an example, the earner may not want to share a badge earned for participating in a political or religious event. A user account webpage provides an “issue key” tab at which a user can adjust the privacy settings on various badges or individuals and create a one-time key that can be directly emailed from the digital badge management and verification platform to the “badge viewer” or separately emailed by the earner to the “badge viewer,” who may be, e.g., a prospective employer. FIG. 18 depicts an example email template for an email in which such a key could be delivered. FIG. 19 depicts an example digital badge display webpage providing access only through a privacy key.

A digital badge management and verification platform is described herein that allows an employer to conduct a search for candidates for an employee position. The employer provides information to the digital badge management and verification platform and subscribes for premium services in order to access a search page that enables the employer to search by badge categories or keywords in order to identify suitable candidates. During such a search, the badge earner's name and contact details are kept confidential. The employer can “request introduction” to a badge earner through a user interface of a webpage of the digital badge management and verification platform. For example, the webpage may provide a button or other user interface widget that, when selected, transmits the requestor's contact information to the candidate, e.g. via email. If the candidate is not interested in the introduction, he/she can “refuse” the introduction.

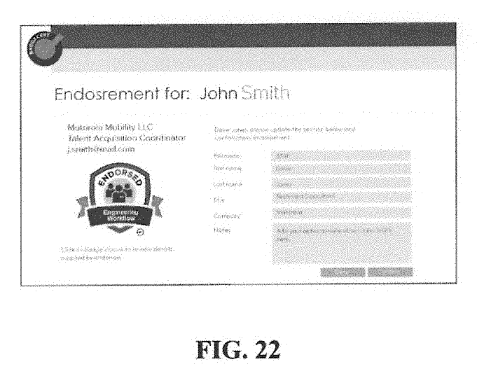

Digital badge management and verification platforms are described herein that allows an earner of a self-reported badge to acquire an endorsement for a self-reported badge. In one implementation, a user interface at which an earner can provide an email address and other information of the endorser at a webpage of a digital badge management and verification platform. FIG. 20 depicts an example user interface supporting entry of endorser identification and contact information. In such an implementation, an email is sent by the digital badge management and verification platform to the prospective endorser requesting an endorsement and details for providing said endorsement. FIG. 21 depicts such an example automated email message configured to be delivered to a prospective endorser of a digital badge. The email transmitted to the endorser may include a link to a web portal landing page where the requested endorsement can be provided. FIG. 22 depicts an example badge endorsement information entry interface at such a web portal landing page.

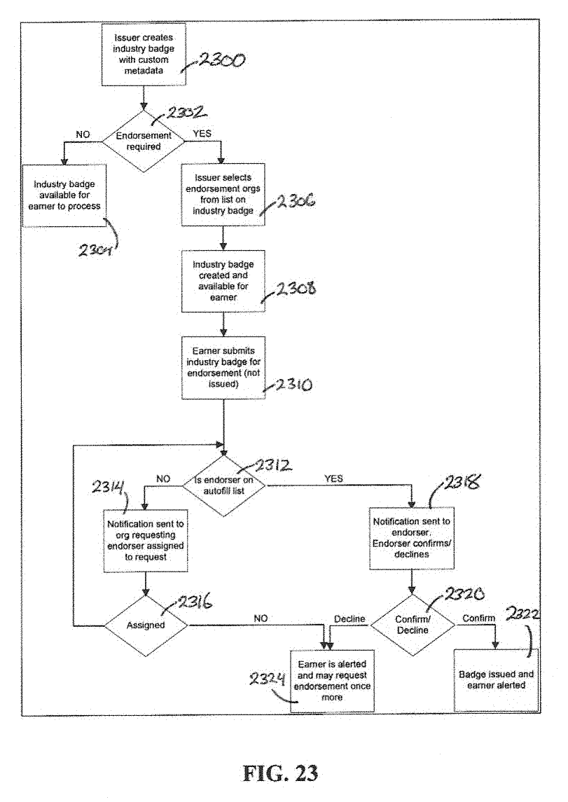

Digital badge management and verification platforms are described herein that allow an earner of a self-reported badge to acquire an endorsement from an authorized endorser. FIG. 23 is a flow chart outlining an example process for issuing a digital badge and acquiring an endorsement of the digital badge from an authorized endorser. At 2300, an issuer creates an industry badge with custom metadata. At 2302, the process determines if an endorsement is required for the badge to issue. If the endorsement is not required, the process proceeds to 2304 where the industry badge is made available for the earner to process. If endorsement is required, the process proceeds to 2306 where the issuer selects endorsement organizations from the list on the industry badge.

At 2308, the industry badge is created and made available for the earner. At 2310 the earner submits the industry badge for endorsement. At 2312, the process determines if the endorser is on an autofill list. If the endorser is not on an autofill list, the process proceeds to 2314 where a notification is sent to the organization requesting an endorser be assigned to the request. If an endorser is not assigned, the process proceeds to 2324 where the earner is alerted and give the opportunity to request endorsement again. Otherwise, the process returns to 2312.

If the process determines that the endorser is on an autofill list, the process proceeds to 2318 where a notification is sent to an endorser and the endorser confirms or declines to endorse the badge. If the endorser confirms, the process proceeds to 2322 where the badge issues and the earner is alerted. If the endorser declines, the process proceeds to 2324 where the earner is alerted and given the opportunity request endorsement again.

An authorized endorser can be a boss, supervisor, or subject matter expert as determined by an organization that created and offered the self-reported badge to the earner. If the badge is part of a competency program which may lead to a certificate, the organization could be an industry association or certifying body. The organization may also be a company. The organization is responsible for provisioning endorsers—or secondarily, for creating authorized organizations which may provision endorsers. An example is a nursing association which allows each hospital to select authorized endorsers for a specific competency such as geriatric nursing. In this case, the organization would visit the certification badge platform portal and upload endorsers (a role in the certification badge platform). When an earner requests an endorsement for a self-reported badge, he/she would pull-down an endorser from a list (or auto fill field) at a user interface component of a webpage of the badge management and verification platform.

The digital badge management and verification platforms described herein have data structure components that may include but are not limited to badge issuers, users, and badges. Badges can be issued automatically via an application programming interface (API), via a certified badge issuing organization on a certification badge platform website, and via self-reporting on a certification badge platform website.

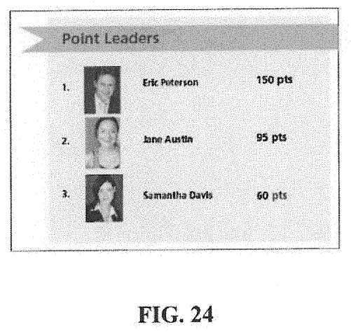

Digital badge management and verification platforms are described herein that provide for display a gamified point total. The gamified point total is a web page that is defined by the groupID and orgID. FIG. 24 depicts an example point earner leaderboard component of a webpage. It can be embedded as an HTML iframe inside a company Intranet site. This can be private via white listed IP address or using a passcode or random numbering scheme.digital badge web portal

Implementations of certification badge platforms described herein provide for a certification process that is applicable to issuers prior to creating and issuing certified badges. The process is similar to Dun & Bradstreet (D&B, DUNS), GSA, iTunes, or Twitter verified accounts. The process requires information that may include the company name, the company headquarters address, the company employer identification number (EIN), the company data universal numbering system (DUNS) number, a company state registration and identification of officers, a letter on company letterhead from a published officer identifying contact is authorized to issue badges, and a domain name match for contact with the company URL.

Digital badge management and verification platforms are described herein that provide for earner feedback via web, text, or other digital medium upon completion of an accomplishment for which a digital badge is issued. Earner feedback may describe his/her experience in undertaking the accomplishment. Examples may include course notes, review, feedback, and other related artifacts and metadata related to the accomplishment. This data may be displayed in the badge data which is viewable on the web, social network, or similar digital medium. This data may be further parsed and tagged and can be categorized to assess training success, reviews of specific trainers, and geographic and other trends in training. This data may be valuable to HR organizations seeking to perform filtered searches of specific training.

Digital badge management and verification platforms are described herein that provide for using other data such as supervisor (to the earner) and corporate quantitative financial and related data quantify the success of the training. As an example, an earner who has taken a financial course may achieve an ROI rating such as: (savings to company)/(cost of training). This data can be acquired, coded, and associated with an issued badge. This may contribute to training reviews and HR evaluation of training programs.

Upon completion of the badge, and at a prescribed interval, the platform notifies the earner's supervisor via email or related communication that the earner completed a badge. Thereafter, the supervisor may be asked a series of survey questions that are (a) standardized by the platform; (b) or created by the company for which the earner works to validate the earner's productivity and performance after the training. This will be analyzed by the platform to determine an over return on investment rating.

Digital badge management and verification platforms are described herein that assess the impact of training, conference attendance, a presentation, etc., based upon several parameters. Such parameters include but are not limited to employee survey and assessment, company data, and supervisor surveys. If such data can be quantified, certification badge platforms of the present application can calculate a return on investment (ROI). Specifically, ROI is calculated as ROI=Value associated with accomplishment and badge/Cost of earning the badge, where Value=net present value of financial improvement (e.g. decreasing expenses or increasing revenue)+value of productivity increases (e.g. % reduction in work to perform tasks×salary)+value of employee retention (anticipated retention improvement×adjusted value of qualified employees—recruiting, training), and Cost=The cost may include: training cost+travel+incidentals+value of employee's time.

Digital badge management and verification platforms are described herein that build demographic profiles of various issuers and earners. Specifically, upon collection of badge metadata and any applicable impact assessment, combined with issuer and earner profile details, the platform is able to assemble analytical data to build demographic profiles of various issuers and earners based upon badge achievement. As an example, if a talented software engineer has earned specific badges (and potentially achieved particular underlying skills with a specified impact) and endorsements—the probably of hiring success is 95%. Certification badge platforms described herein may also provide an interface at which an HR recruiter is able to search by filtering specific badges and/or issuers to determine candidates for a job. A list of candidates (opt-in) and badges and profiles are displayed.

Data collected by certification badge platforms described herein can be used by the public sector, consultants, or related entities to evaluate employment creation, skill cataloguing, and/or trends in education. As an example if a number of employees in a specified area (based upon city, state, county, country, area code ZIP code) have taken a particular training course, it may be worthwhile for planning to purposes to approach companies with interests in the skills being earned in the area.

Data collected by certification badge platforms described herein contemplate the production of badges that have the ability to archive their badge portfolios. It is assumed that in addition to the image icon and plain text metadata, there may be additional data associated with the accomplishment such as documents and references to external web pages. This data is all compiled and stored in a single compressed file such as .zip in order to provide the earner with an archival copy of his/her accomplishments. This file can be downloaded to the user's computing device or an external storage system. The file includes a statement of authenticity. A master folder with a date/time stamp and earnerID will include the file folder structure, letter confirming certification of certifying issuer entities, and the archival process. Subfolders will include each date/time stamp and badgeID pertaining to each badge. Inside each subfolder will include the physical rendering of the badge, a text file with the metadata, and additional artifacts that are associated with the accomplishment. In addition, page scrapes and/or screenshots associated with any website references will be included in each subfolder. Reference websites will be scraped and stored as a screenshot in the folder. For the scape, some of the CSS data may be missing; the scraped page will provide the requisite evidence of the accomplishment underlying the specified badge. The platform will use a commercial scraper for this purpose. New screenshot applications are available that record the entire page as it exists without scraping An application programmer interface (API) is provided herein that facilitates bidirectional exchanges of data that pertain to the creation, issuance, acceptance, and portfolio management of digital badges. The interface is currently is specified as REST, however, it may include JSON, FTP, S/FTP, HTTP(S), and related IP informational exchange technologies. The purpose of the API is to facilitate badge issuance by learning management systems (LMS) and badge and portfolio sharing and maintenance in talent management systems (TMS) and social networking tools. Key components of the API include sharing privileges with issuers, email invitees, and social networks (internal and externals to entities).

In the API of this embodiment, a BADGECERT is a digital award recognizing an accomplishment, a Client is an authorized external application that may create, issue, and/or facilitate management of an earner's BADGECERT portfolio, an orgID is a unique identifying code issued by a digital badge management and verification platform (DBMVP) to a certified issuing authority, an issuer is an entity (company HR, trainer) that has been certified by a DBMVP to issue BADGECERTs to earners, an earner is an individual that has been issued a BADGECERT by an issuer, a viewer is an entity (company HR, career website, and/or social network) that is authorized to view an earner's group of BADGECERTs, a badgeID is a unique identifying code associated with a BADGECERT created by an issuer that does not necessarily imply the BADGECERT has been issued to an earner, an issueID is a unique identifying code associated with a BADGECERT issued by an issuer to an earner, a group is a specified grouping of BADGECERTs by an earner with privacy settings that may entitle a viewer to view the earner's BADGECERTs irrespective of whether the viewer may have issued them, createdDate is the date the BADGECERT was created by the issuer regardless of whether it ever issued, issueDate is the date the BADGECERT was issued by the issuer to the earner, eventDate is the date the requirements towards achieving a BADGECERT was completed, and expirationDate is an optional field that describes the date the BADGECERT may expire, after which the BADGECERT still remains in the earner's portfolio but is described as expired.

The API describes a number of calls. In Add earner (AE), Client adds earners to an organization. Thereafter, an earner can be issued a BADGECERT. In Delete earner (DE), Client deletes earners from an organization, however, the earner remains active in the digital badge management and verification platform to manage, store, and share BADGECERTs. In Create BADGECERT (CB), a training company or HR Manager wishes to recognize completion of an experience such as course, on-line training module, or participation in a leadership conference. In advance of the event, a BADGECERT is created by the Client. Example badges created include a mentorship BADGECERT issued by the company to employees that demonstrate leadership in helping other employees, a training BADGECERT issued by a certified training company to students who have successfully completed a course, a conference attendee is issued a BADGECERT by the conference sponsor who verifies the attendee participated in a conference (e.g. through RFID or bar code verification), and an Issue BADGECERT (TB). Once a BADGECERT has been created, it is issued to BADGECERT earners with additional details of the specific accomplishment.

Once a BADGECERT has been issued, the earner accepts or declines the BADGECERT via web portal or external application. The response is returned to the issuer. Query BADGECERT (QB) allows an authorized system to query the platform for any of the following. If the authorized system is an issuing authority, it may query the certification badge platform for a list of earners for a specified BADGECERT, list of BADGECERTs for a specified earner, or all BADGECERTs within a specified date/time range. If the authorized system is a displaying entity (e.g. career site, social network, HR platform), it may query BC for a list of all BADGECERTs for a specified earner who has authorized the displaying entity to do so. BADGECERT expiration (BE) enables an authorized system can subscribe for expiration notices of issued BADGECERTs. An example would be an earner who has been issued a BADGECERT by a professional association and 30 days in advance and upon expiration, the viewer is notified of the expiration. Add earner email (AEE) enables an earner to add an email address to his/her profile. This offers the ability to earn BADGECERTs under different earner email addresses. This feature is similar to LinkedIn®. In the event the earner does not exist in the system, a new earner is created. Create or Update earner profile (CEP) enables an earner to change his/her profile such as add an email address (similar to LinkedIn®) and update a first and last name and password. If the earner does not exist in the badge certification platform, an account is created. Delete earner email (DEE) enables an earner to delete an email address from his her account so long as he/she has one primary email address.

Create earner group (CEG) enables an earner to create a group to manage BADGECERT sharing privileges. Example groups include: (a) home; (b) work; (c) social; and (d) hobbies. Delete earner group (DEG) enables an earner to delete a group and the applicable sharing privileges. Add BADGECERT(s) to group (ABG) enables an earner to add a BADGECERT to an earner group. Delete BADGECERT(s) from group (DBG) allows an earner to delete a BADGECERT from an earner group. Share group with email address, authorized issuer, or social network (SG) allows an earner to edit sharing privileges with his/her BADGECERT group such as an email address, an authorized issuer orgID, or BC social networking application. UnShare group (USG) permits an earner to remove sharing privileges with his/her BADGECERT group such as an email address, an authorized issuer orgID, or BC social networking application. View earner groups (VEG) allows viewing earner groups with BADGECERTs in each group and group sharing privileges, notify earner of new BADGECERT (NEB) provides that when a BADGECERT is earned by an earner, and the earner has specified a location to which he/she would like to receive notifications, Client is notified of BADGECERT issuance. Earner accept/decline new BADGECERT (EAB) provides for an earner to accept or decline a BADGECERT or BC endorsement in the Client. An Earner issue endorsement (EIE) is a way by which an earner can endorse another BADGECERT earner. Earner self-issue badge (ESB) allows an earner to self-report a BADGECERT for the purpose of describing an accomplishment not documented by a formal issuer. This does not carry as much weight as a certified BADGECERT. Authenticate earner session (AES) allows an earner to login to a Client application or site and remain authenticated to perform earner functions

A provisioning process requires a number of required parameters. Table 8 describes the parameters provided by a digital badge management and verification platform and Client to perform the provisioning process.

TABLE 8
DBMVP and Client provisioning parameters:

| Field | Purpose | Source | Type | Source |
|---|---|---|---|---|
| AuthenticationKey | Unique Client passcode | BC | string | ssdf4jsdfg3 |
| Client IP address | Whitelisting public IP | Client | string | xxx.yyy.zzz.aaa |
| ClientURLER | Acceptance URL | Client | string | http://clientdomain.com/BC |
| ClientURLBE | Expiration FTP URL | Client | string | http://clientdomain.com |
| ClientUserBE | Expiration FTP username | Client | string | bcuser |
| ClientPWBE | Expiration FTP PW | Client | string | ssdf4jsdfg3 |
| ClientURLNEB | BC issuance URL | Client | string | http://clientdomain.com/BC |
| adminEmail | Email address for | Client | String | systemadmin@clientdomain.com |
| | system admin | | | |

Security is provided by requiring all transfers will use https and IP whitelisting. It is recommended that Client applications authorize data transfers from badgecert.com. An authentication key is required in the POST interface.

Health monitoring is provided by monitoring the BC platform for availability and performance. In the event of planned or unplanned maintenance or downtime, BC will notify system administrators. In addition, in the event BC is unsuccessful in forwarding data to a Client application, it will retry the transfer 3 times before notifying system administrators.

An addEarner (AE) API flow is provided in which Client submits HTTP POST with the file xmlrequest and the response is either the file xmlresponse (successful) or one of the specified error codes. All parameter names and alphabetical values are case sensitive. The AE API flow is characterized by:

Operation: AE

Direction: From Client to BC

URL: badgecert.com/api

Method: HTTP POST

Parameters: Table 9

Error codes: Table 10

TABLE 9
AE parameters

| Field | Purpose | Field | Type | Example |
|---|---|---|---|---|
| orgID | Issuing organization ID | Required | int | 0123456789 |
| earnerEmail | Email associated with earner | Require | string | username@mydomain.com |
| earnerFirst | First name of earner | Required | string | Fred |
| earnerLast | Last name of earner | Required | string | Jones |
| earnerTitle | Title of earner | Optional | string | Technical Manager |
| earnerDepartment | Corporate department of earner | Optional | string | Engineering |
| dateAdded | Date earners added to BC | Required | time | 2013 May 24 14:00 |
| authenticationKey | Unique Client passcode | Required | string | ssdf4jsdfg3 |

An XML, request for an AE API flow is provided:

<xmlrequest>
<operation>AE</operation>
<orgID>0123456789</orgID>
<authenticationKey>ssdf4jsdfg3</authenticationKey>
<earners>
<earnerDetails>

<earnerEmail>fjones@badgecert.com</earnerEmail>
<earnerFirst>Fred</earnerFirst>
<earnerLast>Jones</earnerLast >
<earnerTitle>Technical Manager</earnerTitle>
<earnerDepartment>Engineering</earnerDepartment>

</earnerDetails>
<earnerDetails>

<earnerEmail>jaustin@badgecert.com</earnerEmail>
<earnerFirst>Jane</earnerFirst>
<earnerLast>Austin</earnerLast>
<earnerTitle>Engineering Specialist</earnerTitle>
<earnerDepartment>Product Management</earnerDepartment>

</earnerDetails>
</earners>
</xmlrequest>

An XML, response for AE API flow

<xmlresponse>
<operation>AE</operation>
<orgID>0123456789</orgID>
<dateAdded>2013-05-24 14:00</dateAdded>
<earners>
<earnerDetails>

<earnerID>0123456789</earnerID>
<earnerEmail>fjones@badgecert.com</earnerEmail>
<earnerFirst>Fred</earnerFirst>
<earnerLast>Jones</earnerLast >
<earnerTitle>Technical Manager</earnerTitle>
<earnerDepartment>Engineering</earnerDepartment>

</earnerDetails>
<earnerDetails>

<earnerID>0123456789</earnerID>
<earnerEmail>jaustin@badgecert.com</earnerEmail>
<earnerFirst>Jane</earnerFirst>
<earnerLast>Austin</earnerLast >
<earnerTitle>Engineering Specialist</earnerTitle>
<earnerDepartment>Product Management</earnerDepartment>

</earnerDetails>
</earners>
</xmlresponse>

TABLE 10
AE error codes

| Response | Purpose |
|---|---|
| A500 | Internal error occurred. Please contact an administrator. |
| A501 | Not all required information was supplied. |
| A502 | Operation not valid. |
| A503 | orgID not valid. |
| A504 | Incorrect authenticationKey. |
| A505 | Format for earner details incorrect. |

While the earner is removed from the organizational roster, he/she remains active in BC to manage, store, and display issued BADGECERTS. The deleteEarner (DE) API call flow provides:

Operation: DE

Direction: From Client to BC

URL: badgecert.com/api

Method: HTTP POST

Parameters: Table 11

Error codes: Table 12

TABLE 11
DE parameters

| Field | Purpose | Field | Type | Example |
|---|---|---|---|---|
| orgID | Issuing organization | Required | int | 0123456789 |
| | ID | | | |
| earnerID | ID associated with | Require | string | 0123456789 |
| | earner | | | |
| dateDeleted | Date earners deleted | Required | time | 2013 May 24 |
| | from BC | | | 14:00 |
| authenticationKey | Unique Client | Required | string | ssdf4jsdfg3 |
| | passcode | | | |

Example DE XML request:

<xmlrequest>

<operation>DE</operation>
<orgID>0123456789</orgID>
<authenticationKey>ssdf4jsdfg3</authenticationKey>
<earners>

<earnerID>0123456789</earnerID>
<earnerID>0123456789</earnerID>

</Earners>

</xmlrequest>

Example DE XML response:

<xmlresponse>

<operation>DE</operation>
<orgID>0123456789</orgID>
<dateDeleted>2013-05-24 14:00</dateDeleted>
<earners>

<earnerDetails>

<earnerID>0123456789</earnerID>
<earnerEmail>fjones@badgecert.com</earnerEmail>
<earnerFirst>Fred</earnerFirst>
<earnerLast>Jones</earnerLast >
<earnerTitle>Technical Manager</earnerTitle>
<earnerDepartment>Engineering</earnerDepartment>

</earnerDetails>
<earnerDetails>

<earnerID>0123456789</earnerID>
<earnerEmail>jaustin@badgecert.com</earnerEmail>
<earnerFirst>Jane</earnerFirst>
<earnerLast>Austin</earnerLast>
<earnerTitle>Engineering Specialist</earnerTitle>
<earnerDepartment>Product Management</earnerDepartment>

</earnerDetails>

<earners>

</xmlresponse>

TABLE 1
DE error codes

| Response | Purpose |
|---|---|
| A500 | Internal error occurred. Please contact an administrator. |
| A501 | Not all required information was supplied. |
| A502 | Operation not valid. |
| A503 | orgID not valid. |
| A504 | Incorrect authenticationKey. |
| A505 | No earners found. |

In Create BADGECERT (CB)

Before issuing a BADGECERT, it must be created by the issuer. The Create BADGECERT (CB) API call provides:

### Operation: CB

### Direction: From Client to BC

URL: badgecert.com/api

### Method: HTTP POST

### Parameters: Table 13

Error codes: Table 14

TABLE 13
CB parameters

| Field | Purpose | Field | Type | Example |
|---|---|---|---|---|
| orgID | Issuing organization ID | Required | int | 0123456789 |
| contactID | Identification number of | Optional | Int | 0123456789 |
| | authorized contact in | | | |
| | Company registered on | | | |
| | BC | | | |
| gamePoints | Gamification value of | Optional | int | 15 |
| | BADGECERT | | | |
| iconID | URL of JPEG image | Required | string | http://yoursite.com/abc01234.jpg |
| | associated with | | | |
| | BADGECERT icon | | | |
| ringColor | Color of badge outer | Required | string | red, blue, purple, gold, grey |
| | ring | | | |
| badgeTitle | Title displayed on | Required | string | Power Training Course |
| | BADGECERT (50 | | | |
| | characters) | | | |
| badgeLongDesc | Long description | Optional | memo | Earner completed weeklong |
| | describing badge (500 | | | course on power training |
| | characters) | | | at the Motor Company facility |
| | | | | in Detroit. Course included |
| | | | | training on power system, |
| | | | | introduction, hands-on training, |
| | | | | and computer simulation. |
| createdDate | Date/time | Required | time | 2013 May 24 14:00 |
| | BADGECERT created | | | |
| | by BC | | | |
| badgeNotes | Data associated with | Optional | NVP | Error! Reference source not |
| | requirements to earn a | | | found. |
| | BADGECERT, name | | | |
| | value pairs | | | |
| authenticationKey | Unique Client passcode | Required | string | ssdf4jsdfg3 |

Example CB XML, request:

<xmlrequest>
<operation>CB</operation>
<orgID>0123456789</orgID>
<authenticationKey>ssdf4jsdfg3 </authenticationKey>
<badgeTitle>Power Training Course</badgeTitle>
<iconID>http://yoursite.com/abc01234.jpg</iconID>
<ringColor>purple</ringColor>
<contactID>0123456789</contactID>
< badgeLongDesc> Earner completed weeklong course on power training
at the Motor Company facility in Detroit.
Course included training on power system, introduction, hands-on training,
and computer simulation.
</badgeLongDesc>
<badgeNotes>

<note>
<name>Duration</name>
<value>40 hours</value>
<note>
<note>
<name>Cost</name>
<value>$1,500</value>
<note>
<note>
<name>Objective</name>

<value>Able to successfully demonstrate removal and installation of a new
Power System.</value>

<note>
<note>
<name>Metric</name>
<value>Instructor observation</value>
<note>
<note>
<name>Address</name>
<value>275 Pineridge Rd, Detroit, Michigan, USA</value>
<note>

</badgeNotes >
</xmlrequest>

Example CB XML:

<xmlresponse>
<operation>CB</operation>
<orgID>0123456789</orgID>
<badgeID>0123456789</badgeID>
<CreatedDate>2013-05-24 14:00</badgeID>
<badgeTitle>Power Training Course</badgeTitle>
<iconID>http://yoursite.com/abc01234.jpg</iconID>
<ringColor>purple</ringColor>
<contactID>0123456789</contactID>
<badgeLongDesc> Earner completed weeklong course on power training
at the Motor Company facility in Detroit.
Course included training on power system, introduction, hands-on training,
and computer simulation.
</badgeLongDesc>
<badgeNotes>

<note>
<name>Duration</name>
<value>40 hours</value>
<note>
<note>
<name>Cost</name>
<value>$1,500</value>
<note>
<note>
<name>Objective</name>
<value>Able to successfully demonstrate removal and installation of

a new Power</value>

<note>
<note>
<name>Metric</name>
<value>Instructor observation</value>
<note>
<note>
<name>Address</name>
<value>275 Pineridge Rd, Detroit, Michigan, USA</value>
<note>

</badgeNotes>
</xmlresponse>

TABLE 14
CB error codes

| Response | Purpose |
|---|---|
| A500 | Internal error occurred. Please contact an administrator. |
| A501 | Not all required information was supplied. |
| A502 | Operation not valid. |
| A503 | orgID not found. |
| A504 | Incorrect authenticationKey. |
| A505 | badgeID not valid. Must be numeric and =<8 characters. |
| A506 | gamePoints not valid. |
| A507 | iconID invalid. |
| A508 | ringColor invalid. |
| A509 | contactID invalid. |
| A510 | badgeTitle must be valid and =<50 characters. |
| A511 | badgeLongDesc must be valid and =<500 characters. |
| A512 | badgeNotes not correct format. |

A BADGECERT is issued only by an issuer to an earner once it has been created by the issuer. The Issue BADGECERT (IB) API call provides:

### Operation: IB

### Direction: From Client to BC

URL: badgecert.com/api

### Method: HTTP POST

### Parameters: Table 15

Error codes: Table 16

TABLE 15
IB parameters

| Field | Purpose | Field | Type | Example |
|---|---|---|---|---|
| badgeID | badgeID for created | Required | int | 0123456789 |
| | BADGECERT | | | |
| orgID | Issuer organization | Required | int | 0123456789 |
| | ID | | | |
| issueID | issueID for issued | Required | int | 0123456789 |
| | BADGECERT | | | |
| earnerID | ID of earner to which | Required | string | 0123456789 |
| | BADGECERT is | | | |
| | issued | | | |
| overPointsEarned | Any adjustment to | Optional | int | −5 |
| | gamePoints on a per | | | |
| | earner basis | | | |
| eventDate | Date/time | Required | time | 2013 May 24 14:00 |
| | BADGECERT issued | | | |
| issueDate | Date/time | Required | time | 2013 May 24 14:00 |
| | BADGECERT issued | | | |
| | by BC | | | |
| expirationDate | Date/time | Optional | time | 2013 May 24 14:00 |
| | BADGECERT expires | | | |
| trainerName | Name of trainer | Optional | string | Fred Jones |
| | issuing BADGECERT | | | |
| location | Where badge was | Required | string | Detroit, MI |
| | issued | | | |
| issueNotes | Data associated with | Optional | NVP | See FIG. 3 |
| | requirements to earn | | | |
| | a badge, name value | | | |
| | pairs | | | |
| artifact1PDF | Location of 1st | Optional | string | http://yoursite.com/abc01234.pdf |
| | PDF artifact file | | | |
| artifact2PDF | Location of 2nd | Optional | string | http://yoursite.com/abc01234.pdf |
| | PDF artifact file | | | |
| artifact1Web | URL of 1st artifact | Optional | string | http://dropbox.com/0123456789 |
| | (reference only) | | | |
| artifact2Web | URL of 2nd artifact | Optional | string | http://dropbox.com/0123456789 |
| | (reference only) | | | |
| authenticationKey | Unique Client passcode | Required | string | ssdf4jsdfg3 |

Example IB XML, request

<xmlrequest>
<operation>IB</operation>
<badgeID>0123456789</badgeID>
<orgID>0123456789</orgID>
<earnerID>0123456789</earnerID>
<overPointsEarned>−5</overPointsEarned>
<eventDate>2013-05-24 14:00</eventDate>
<expirationDate>2013-05-24 14:00<expirationDate>
<trainerName>Fred Jones</trainerName>
<location>Detroit, MI</location>
<authenticationKey> ssdf4jsdfg3</authenticationKey>
<artifact1PDF>http://yoursite.com/abc01234.pdf</artifact1PDF>
<artifact2PDF>http://yoursite.com/abc01234.pdf</artifact2PDF>
<artifact1Web>http://dropbox.com/0123456789</artifact1Web>
<artifact2Web>http://dropbox.com/0123456789</artifact2Web>
<issueNotes>

<note>
<name>startDate</name>
<value>2011-05-06 11:28</value>
</note>
<note>
<name>endDate</name>
<value>2011-05-06 11:28</value>
<note>
<note>
<name>Reflection</name>
<value> No reflection provided </value>
<note>
<note>
<name>Final Score</name>
<value>75%</value>
<note>

</issueNotes >
</xmlrequest>

Example IB XML response:

<xmlresponse>
<operation>IB</operation>
<badgeID>0123456789</badgeID>
<orgID>0123456789</orgID>
<earnerID>0123456789</earnerID>
<issueID>0123456789</issueID>
<overPointsEarned>−5</overPointsEarned>
<issueDate>2013-05-24 14:00</issueDate >
<eventDate>2013-05-24 14:00</eventDate>
<expirationDate>2013-05-24 14:00<expirationDate>
<trainerName>Fred Jones</trainerName>
<location>Detroit, MI</location>
<artifact1PDF>http://yoursite.com/abc01234.pdf</artifact1PDF>
<artifact2PDF>http://yoursite.com/abc01234.pdf</artifact2PDF>
<artifact1Web>http://dropbox.com/0123456789</artifact1Web>
<artifact2Web>http://dropbox.com/0123456789</artifact2Web>
<issueNotes>

<note>
<name>startDate</name>
<value>2011-05-06 11:28</value>
</note>
<note>
<name>endDate</name>
<value>2011-05-06 11:28</value>
<note>
<note>
<name>Reflection</name>
<value> No reflection provided </value>
<note>
<note>
<name>Final Score</name>
<value>75%</value>
<note>

</issueNotes >
</xmlresponse>

TABLE 2
IB error codes

| Response | Purpose |
|---|---|
| A500 | Internal error occurred. Please contact an administrator. |
| A501 | Not all required information was supplied. |
| A502 | Operation not valid. |
| A503 | orgID not found. |
| A504 | Incorrect authenticationKey. |
| A505 | badgeID not found for this orgID. |
| A506 | earnerID not found for this orgID. |
| A507 | overPointsEarned not valid. |
| A508 | trainerName must be =<50 characters. |
| A509 | Location must be =<100 characters. |
| A510 | badgeLongDesc must be valid and =<500 characters. |
| A511 | eventDate not correct format. |
| A512 | expirationDate not correct format. |
| A513 | issueNotes not correct format. |
| A514 | artifactPDF not correct format. |
| A515 | artifactWeb not correct format. |

The Earner response (ER) API call provides:

### Operation: ER

### Direction: BC to Client

### URL: ClientURLER

### Method: HTTP POST

### Parameters: Table 17

TABLE 17
ER parameters

| Field | Purpose | Field | Example |
|---|---|---|---|
| issueID | Unique ID associated | Required | 0123456789 |
| | with BADGECERT | | |
| | issued to earner | | |
| earnerAcceptance | Earner acceptance code | Required | 1 - Accepted |
| | | | 2 - Declined |

ER XML response:

<xmlresponse>
<operation>ER</operation>
<issueID>0123456789</issueID>
<earnerAcceptance>1</earnerAcceptance>
</xmlresponse>

The Query BADGECERT (QB) API call provides:

### Operation: QB

### Direction: From Client to BC

URL: badgecert.com/api

### Method: HTTP POST

### Parameters: Table 18

Error codes: Table 19

TABLE 18
QB parameters

| Field | Purpose | Field | Type | Example |
|---|---|---|---|---|
| badgeID | Identification of | Optional | int | 0123456789 |
| | created BADGECERT | | | |
| orgID | Badge issuing | Optional | int | 0123456789 |
| | organization ID | | | |
| earnerID | Username of earner to | Optional | string | username@mydomain.com |
| | which badge was | | | |
| | issued | | | |
| issueID | Identification of | Optional | int | 0123456789 |
| | issued BADGECERT | | | |
| rangeType | Type of date/time | Optional | int | 1 - Event date/time |
| | search | | | 2 - Issued date/time |
| | | | | 3 - Expired date/time |
| startDateRange | Search start date/time | Optional | time | 2013-05-24 14:00 |
| | badge (GMT) | | | |
| endDateRange | Search end date/time | Optional | time | 2013-05-24 14:00 |
| | badge (GMT) | | | |
| authenticationKey | Unique Client | Required | string | ssdf4jsdfg3 |
| | passcode | | | |

QB XML, request:

<xmlrequest>

<operationID>QB</operationID>
<authenticationKey>ssdf4jsdfg3</authenticationKey>
<badgeID>0123456789</badgeID>
<orgID>0123456789</orgID>

<rangeType>2</rangeType>
<period>

<startDateRange>2013-05-24 14:00</startDateRange>
<endDateRange>2013-08-24 14:00</endDateRange>

</period>
</xmlrequest>

QB XML response:

<xmlresponse>

<operationID>QB</operationID>
<badgeID>0123456789</badgeID>
<orgID>0123456789</orgID>
<issueDetails>

<issuedBADGECERT>

<earnerID>tjones@mydomain.com</earnerID>
<issueID>0123456789<issueID>
<issuedDate>2013-05-24 14:00</issuedDate>
<issuedBADGECERT>

<issuedBADGECERT>

<earnerID>bschwartz@mydomain.com</earnerID>
<issueID>0123456789<issueID>
<issuedDate>2013-05-24 14:00</issuedDate>
<issuedBADGECERT>
<issueDetails>

<rangeType>2</rangeType>
<period>

<startDateRange>2013-05-24 14:00</startDateRange>
<endDateRange>2013-08-24 14:00</endDateRange>

</period>
</xmlresponse>

TABLE 19
QB error codes

| Response | Purpose |
|---|---|
| A500 | Internal error occurred. Please contact an administrator. |
| A501 | Not all required information was supplied. |
| A502 | Operation not valid. |
| A503 | orgID not found. |
| A504 | Incorrect authenticationKey. |
| A505 | badgeID not found for this orgID. |
| A506 | rangeType not valid. |
| A507 | Period not valid. |

The BADGECERT expiration (BE) API call provides:

### Direction: From BC to Client

### Format: CSV

### Method: FTP

URL: Client specified FTP site

### Parameters: Table 20

TABLE 20
BE parameters

| Field | Purpose | Field | Example |
|---|---|---|---|
| issueID | Unique ID associated | Required | 0123456789 |
| | with BADGECERT | | |
| | issued to earner | | |
| earnerID | Earner for expiring | Required | 0123456789 |
| | badge | | |
| exprirationDate | Earner expiration date | Required | 2013-05-24 14:00 |

For the BE API call, the recurring batch file will include all qualifying BADGECERTS applicable to the organization. All parameter names and alphabetical values are case sensitive. When subscribed, the Client will receive notification 30 days prior to and upon expiration. Client will attempt to retry sending the file three times in the event a failure is detected. Thereafter, an alert will be sent to system administrators.

The Create or Update earner profile (CEP) API call provides:

### Operation: CEP

### Direction: From Client to BC

URL: badgecert.com/api

### Method: HTTP POST

### Parameters: Table 21

Error codes: Table 22

TABLE 21
CEP parameters

| Field | Purpose | Field | Type | Example |
|---|---|---|---|---|
| earnerID | ID associated with | Optional | int | 0123456789 |
| | earner | | | |
| earnerEmail_new | New email to be | Optional | string | username@newmydomain.com |
| | associated with earner | | | |
| earnerPW_new | New earner account PW | Optional | string | ssdf4jsdfg3 |
| earnerEmail | Email associated with | Optional | string | username@olddomain.com |
| | earner | | | |
| earnerPW | Earner account | Optional | string | ssdf4jsdfg3 |
| | password | | | |
| earnerFirst | First name of earner | Optional | string | Fred |
| earnerLast | Last name of earner | Optional | string | Jones |
| dateUpdated | Date earner profile | Required | time | 2013-05-24 14:00 |
| | updated | | | |
| authentication | Unique Client passcode | Required | string | ssdf4jsdfg3 |
| Key | | | | |

For existing earner account, either earnerEmail or earnerID required and earnerPW.
To create new earner account, earnerEmail_new and earnerPW_new required.

CEP XML, request:

<xmlrequest>
<operation>CEP</operation>
<authenticationKey>ssdf4jsdfg3</authenticationKey>
<earnerDetails>

<earnerID>0123456789</earnerID>
<earnerEmail>fjones@olddomain.com</earnerEmail>
<earnerEmail_new>fjones@newdomain.com</earnerEmail_new>
<earnerPW ssdf4jsdfg3</earnerPW>

</earnerDetails>
</xmlrequest>
<xmlrequest>
<operation>CEP</operation>
<authenticationKey>ssdf4jsdfg3</authenticationKey>
<earnerDetails>

<earnerID>0123456789</earnerID>
<earnerPW_new>ssdf4jsdfg3</earnerPW_new>
<earnerPW ssdf4jsdfg3</earnerPW>

</earnerDetails>
</xmlrequest>
<xmlrequest>
<operation>CEP</operation>
<authenticationKey>ssdf4jsdfg3</authenticationKey>
<earnerDetails>
<earnerDetails>

<earnerEmail_new>janeaustin@newdomain.com</earnerEmail_new>
<earnerFirst>Jane</earnerFirst>
<earnerLast>Austin</earnerLast >
<earnerPW ssdf4jsdfg3</earnerPW>

</earnerDetails>
</xmlrequest>

CEP XML, response:

<xmlresponse>
<operation>CEP</operation>
<dateUpdated>2013-05-24 14:00</dateUpdated>
<earnerDetails>

<earnerID>0123456789</earnerID>
<earnerEmailaccounts>
<earnerEmail_1>fjones@olddomain.com</earnerEmail_1>
<earnerEmail_2>fjones@newdomain.com</earnerEmail_2>
</earnerEmailaccounts>
<earnerFirst>Fred</earnerFirst>
<earnerLast>Jones</earnerLast >

</earnerDetails>
</xmlresponse>
<xmlresponse>
<operation>CEP</operation>
<dateUpdated>2013-05-24 14:00</dateUpdated>
<earnerDetails>

<earnerID>0123456789</earnerID>
<earnerEmailaccounts>
<earnerEmail_1>rbobby@newdomain.com</earnerEmail_1>
</earnerEmailaccounts>
<earnerFirst>Ricky</earnerFirst>
<earnerLast>Bobby</earnerLast >

</earnerDetails>
</xmlresponse>
<xmlresponse>
<operation>CEP</operation>
<dateUpdated>2013-05-24 14:00</dateUpdated>
<earnerDetails>

<earnerID>0123456789</earnerID>
<earnerEmailaccounts>
<earnerEmail_1>janeaustin@newdomain.com</earnerEmail_1>
</earnerEmailaccounts>
<earnerFirst>Jane</earnerFirst>
<earnerLast>Austin</earnerLast >

</earnerDetails>
</xmlresponse>

TABLE 22
CEP error codes

| Response | Purpose |
|---|---|
| A500 | Internal error occurred. Please contact an administrator. |
| A501 | Not all required information was supplied. |
| A502 | Operation not valid. |
| A503 | earnerID not valid. |
| A504 | Incorrect authenticationKey. |
| A505 | Format for earner details incorrect. |
| A506 | earnerEmail not valid. |
| A507 | Incorrect earnerPW |
| A508 | earnerEmail_new already exists for another earner |
| | account. |

The Delete earner email (DEE) API provides:

### Operation: DEE

### Direction: From Client to BC

URL: badgecert.com/api

### Method: HTTP POST

### Parameters: Table 23

Error codes: Table 24

TABLE 23
DEE parameters

| Field | Purpose | Field | Type | Example |
|---|---|---|---|---|
| earnerEmail | Email to be deleted from | Required | string | username@newmydomain.com |
| | earner account | | | |
| earnerID | ID associated with | Optional | int | 0123456789 |
| | earner | | | |
| earnerPW | Earner account password | Required | string | ssdf4jsdfg3 |
| dateDeleted | Date earner email | Required | time | 2013-05-24 14:00 |
| | deleted from BC | | | |
| authentication | Unique Client passcode | Required | string | ssdf4jsdfg3 |
| Key | | | | |

DEE XML request

<xmlrequest>
<operation>DEE</operation>
<authenticationKey>ssdf4jsdfg3</authenticationKey>
<earnerDetails>

<earnerID>0123456789</earnerID>
<earnerEmail>fjones@olddomain.com</earnerEmail>
<earnerPW ssdf4jsdfg3</earnerPW>

</earnerDetails>
</xmlrequest>

DEE XML, response

<xmlresponse>
<operation>DEE</operation>
<dateDeleted>2013-05-24 14:00</dateDeleted>
<earnerDetails>

<earnerID>0123456789</earnerID>
<earnerEmail>fjones@newdomain.com</earnerEmail>
<earnerEmail_deleted>
fjones@olddomain.com</earnerEmail_deleted>
<earnerFirst>Fred</earnerFirst>
<earnerLast>Jones</earnerLast >

</earnerDetails>
</xmlresponse>

TABLE 24
DEE error codes

| Response | Purpose |
|---|---|
| A500 | Internal error occurred. Please contact an administrator. |
| A501 | Not all required information was supplied. |
| A502 | Operation not valid. |
| A503 | Incorrect authenticationKey. |
| A504 | earnerID not valid. |
| A505 | earnerEmail not valid. |
| A506 | Format for earner details incorrect. |
| A507 | Incorrect earnerPW |
| A508 | Cannot remove primary email. |

The Create earner group (CEG) provides:

### Operation: CEG

### Direction: From Client to BC

URL: badgecert.com/api

### Method: HTTP POST

### Parameters: Table 25

Error codes: Table 26

TABLE 25
CEG parameters

| Field | Purpose | Field | Type | Example |
|---|---|---|---|---|
| earnerEmail | Email associated with | Optional | string | username@newmydomain.com |
| | earner | | | |
| earnerID | ID associated with | Optional | int | 0123456789 |
| | earner | | | |
| earnerPW | Earner account password | Required | string | ssdf4jsdfg3 |
| groupName | Earner group name (<25 | Required | string | Art |
| | chars) | | | |
| groupID | Earner group ID | Optional | int | 0123456789 |
| groupIcon | Image to be displayed | Optional | Int | 1 - home |
| | with group on portal | | | 2 - work |
| | | | | 3 - athletics |
| | | | | 4 - club |
| | | | | 5 - personal |
| dateUpdated | Date earner group | Required | time | 2013-05-24 14:00 |
| | updated | | | |
| authentication | Unique Client passcode | Required | string | ssdf4jsdfg3 |
| Key | | | | |

Either earnerEmail or earnerID required. A confirmation email is sent to the earner.

CEG XML request

<xmlrequest>
<operation>CEG</operation>
<authenticationKey>ssdf4jsdfg3</authenticationKey>
<earnerDetails>

<earnerID>0123456789</earnerID>
<earnerPW ssdf4jsdfg3</earnerPW>

<groupDetails>

<groupID>0123456789</groupID>
<groupName>Art</groupName>
<groupIcon>4</groupIcon>
</groupDetails>

</xmlrequest>
<xmlrequest>
<operation>CEG</operation>
<authenticationKey>ssdf4jsdfg3</authenticationKey>
<earnerDetails>

<earnerEmail>rbobby@domainname.com</earnerEmail>
<earnerPW ssdf4jsdfg3</earnerPW>

<groupDetails>

<groupName>Golf</groupName>
<groupIcon>3</groupIcon>
</groupDetails>

</xmlrequest>

CEG XML, response:

<xmlresponse>
<operation>CEG</operation>
<dateUpdated>2013-05-24 14:00</dateUpdated>
<earnerDetails>

<earnerID>0123456789</earnerID>

<groupDetails>

<groupID>0123456789</earnerID>
<groupName>Art</groupName>
<groupIcon>4</groupIcon>
</groupDetails>

</xmlresponse>

<xmlresponse>
<operation>CEG</operation>
<dateUpdated>2013-05-24 14:00</dateUpdated>
<earnerDetails>

<earnerEmail>rbobby@domainname.com</earnerEmail>

<groupDetails>

<groupID>0123456789</earnerID>
<groupName>Golf</groupName>
<groupIcon>3</groupIcon>
</groupDetails>

</xmlresponse>

TABLE 26
CEG error codes

| Response | Purpose |
|---|---|
| A500 | Internal error occurred. Please contact an administrator. |
| A501 | Not all required information was supplied. |
| A502 | Operation not valid. |
| A503 | Incorrect authenticationKey. |
| A504 | earnerID not valid. |
| A505 | earnerEmail not valid. |
| A506 | Incorrect earnerPW |
| A507 | groupID not valid. |
| A508 | groupName not valid. |
| A509 | groupName format not valid (<25 characters) |
| A510 | groupDetails format not valid. |
| A5110 | groupName already exists. |

The Delete earner group (DEG) API flow provides:

### Operation: DEG

### Direction: From Client to BC

URL: badgecert.com/api

### Method: HTTP POST

### Parameters: Table 27

Error codes: Table 28

TABLE 27
DEG parameters

| Field | Purpose | Field | Type | Example |
|---|---|---|---|---|
| earnerEmail | Email associated with | Optional | string | username@newmydomain.com |
| | earner | | | |
| earnerID | ID associated with | Optional | int | 0123456789 |
| | earner | | | |
| earnerPW | Earner account password | Required | string | ssdf4jsdfg3 |
| groupName | Earner group name (<25 | Optional | string | Art |
| | chars) | | | |
| groupID | Earner group ID | Optional | int | 0123456789 |
| dateDeleted | Date earner group | Required | time | 2013-05-24 14:00 |
| | updated | | | |
| authentication | Unique Client passcode | Required | string | ssdf4jsdfg3 |
| Key | | | | |

Either earnerEmail or earnerID required and either groupName or groupID is required. An earner may not remove restricted access groups from his/her account such as All Badges. A confirmation email is sent to the earner.

DEG XML request

<xmlrequest>
<operation>DEG</operation>
<authenticationKey>ssdf4jsdfg3</authenticationKey>
<earnerDetails>

<earnerID>0123456789</earnerID>
<earnerPW ssdf4jsdfg3</earnerPW>

<groupDetails>

<groupID>0123456789</earnerID>
</groupDetails>

</xmlrequest>

DEG XML response

<xmlresponse>
<operation>DEG</operation>
<dateDeleted>2013-05-24 14:00</dateDeletedd>
<earnerDetails>

<earnerID>0123456789</earnerID>

<groupDetails>

<groupID>0123456789</earnerID>
<groupName>Art</groupName>
</groupDetails>

</xmlresponse>

TABLE 28
DEG error codes

| Response | Purpose |
|---|---|
| A500 | Internal error occurred. Please contact an administrator. |
| A501 | Not all required information was supplied. |
| A502 | Operation not valid. |
| A503 | Incorrect authenticationKey. |
| A504 | earnerID not valid. |
| A505 | earnerEmail not valid. |
| A506 | Incorrect earnerPW |
| A507 | groupID not valid. |
| A508 | groupName not valid. |
| A509 | groupDetails format not valid. |
| A510 | Restricted group; cannot be deleted. |

The Add BADGECERT(s) to group (ABG) API flow provides:

### Operation: ABG

### Direction: From Client to BC

URL: badgecert.com/api

### Method: HTTP POST

### Parameters: Table 29

Error codes: Table 30

TABLE 29
ABG parameters

| Field | Purpose | Field | Type | Example |
|---|---|---|---|---|
| earnerEmail | Email associated with | Optional | string | username@newmydomain.com |
| | earner | | | |
| earnerID | ID associated with | Optional | int | 0123456789 |
| | earner | | | |
| earnerPW | Earner account password | Required | string | ssdf4jsdfg3 |
| groupID | Earner group ID | Optional | int | 0123456789 |
| issueID | Issued (and accepted) | Optional | Int | 0123456789 |
| | badge ID | | | |
| dateAdded | Date badge added to | Required | time | 2013-05-24 14:00 |
| | group | | | |
| authentication | Unique Client passcode | Required | string | ssdf4jsdfg3 |
| Key | | | | |

Either earnerEmail or earnerID required.

ABG XML request:

<xmlrequest>
<operation>ABG</operation>
<authenticationKey>ssdf4jsdfg3</authenticationKey>
<earnerDetails>

<earnerID>0123456789</earnerID>
<earnerPW ssdf4jsdfg3</earnerPW>

<groupID>0123456789</groupID>
<issueID>0123456789</issueID>
</xmlrequest>

ABG XML, response:

<xmlresponse>
<operation>ABG</operation>
<dateAdded>2013-05-24 14:00</dateAdded>
<earnerID>0123456789</earnerID>
<groupID>0123456789</groupID>

<issueID>0123456789</issueID>

</xmlresponse>

TABLE 30
ABG error codes

| Response | Purpose |
|---|---|
| A500 | Internal error occurred. Please contact an administrator. |
| A501 | Not all required information was supplied. |
| A502 | Operation not valid. |
| A503 | Incorrect authenticationKey. |
| A504 | earnerID not valid. |
| A505 | earnerEmail not valid. |
| A506 | Incorrect earnerPW |
| A507 | groupID not valid. |
| A508 | badgeID not valid. |
| A509 | badgeID already in group. |
| A510 | badgeID not authorized to add to this group. |

A Delete BADGECERT(s) from group (DBG) API flow provides:

### Operation: DBG

### Direction: From Client to BC

URL: badgecert.com/api

### Method: HTTP POST

### Parameters: Table 31

Error codes: Table 32

TABLE 31
DBG parameters

| Field | Purpose | Field | Type | Example |
|---|---|---|---|---|
| earnerEmail | Email associated with | Optional | string | username@newmydomain.com |
| | earner | | | |
| earnerID | ID associated with | Optional | int | 0123456789 |
| | earner | | | |
| earnerPW | Earner account password | Required | string | ssdf4jsdfg3 |
| groupID | Earner group ID | Required | int | 0123456789 |
| issueID | Issued badge ID | Required | Int | 0123456789 |
| dateDeleted | Date badge deleted from | Required | time | 2013-05-24 14:00 |
| | group | | | |
| authentication | Unique Client passcode | Required | string | ssdf4jsdfg3 |
| Key | | | | |

Either earnerEmail or earnerID required.

DGB XML request:

<xmlrequest>
<operation>DBG</operation>
<authenticationKey>ssdf4jsdfg3</authenticationKey>
<earnerDetails>

<earnerID>0123456789</earnerID>
<earnerPW ssdf4jsdfg3</earnerPW>

</earnerDetails>
<groupID>0123456789</groupID>
<issueID>0123456789</issueID>
</xmlrequest>

DBG earner group XML, response

<xmlrequest>
<xmlresponse>
<operation>DBG</operation>
<dateDeleted>2013-05-24 14:00</dateDeleted>
<earnerID>0123456789</earnerID>
<groupID>0123456789</groupID>

<issueID>0123456789</issueID>

</xmlresponse>

TABLE 32
DBG error codes

| Response | Purpose |
|---|---|
| A500 | Internal error occurred. Please contact an administrator. |
| A501 | Not all required information was supplied. |
| A502 | Operation not valid. |
| A503 | Incorrect authenticationKey. |
| A504 | earnerID not valid. |
| A505 | earnerEmail not valid. |
| A506 | Incorrect earnerPW |
| A507 | groupID not valid. |
| A508 | badgeID not valid. |
| A509 | badgeID not in group. |
| A510 | badgeID not authorized to delete badge from this group. |

A Share group (SG) API flow provides: Operation: SG

### Direction: From Client to BC

URL: badgecert.com/api

### Method: HTTP POST

### Parameters: Table 33

Error codes: Table 34

TABLE 33
SG parameters

| Field | Purpose | Field | Type | Example |
|---|---|---|---|---|
| earnerEmail | Email associated with | Optional | string | username@newmydomain.com |
| | earner | | | |
| earnerID | ID associated with | Optional | int | 0123456789 |
| | earner | | | |
| earnerPW | Earner account password | Required | string | ssdf4jsdfg3 |
| groupID | Earner group ID | Required | int | 0123456789 |
| channel | Channel with which | Required | Int | 1 - Email |
| | group is shared (check | | | 2 - LinkedIn ® |
| | for availability) | | | 3 - Facebook ® |
| userName | Email address or | Required | int | username@domain.com |
| | username | | | |
| channelPW | Password for email | Optional | int | Channel password |
| | channel | | | (except email) |
| dateExpiration | Date sharing disabled | Optional | Int | 2013-05-24 14:00 |
| dateShared | Date group shared | Required | time | 2013-05-24 14:00 |
| authentication | Unique Client passcode | Required | string | ssdf4jsdfg3 |
| Key | | | | |

Either earnerEmail or earnerID required. Email with a secure URL is sent to any email addresses with whom the group is shared. An earner may have multiple userNames for the same channel. If an identical channel and userName is already being shared, any updates are overwritten.

Share group XML, request (SG):

<xmlrequest>
<xmlrequest>
<operation>SG</operation>
<authenticationKey>ssdf4jsdfg3</authenticationKey>
<earnerDetails>

<earnerID>0123456789</earnerID>
<earnerPW ssdf4jsdfg3</earnerPW>

</earnerDetails>
<groupID>0123456789</groupID>
<channelDetails>

<channel>1</channel>

<userName>rbobby@company.com</userName>
<channelPW>ssdf4jsdfg3</channelPW>

</channelDetails>

</xmlrequest>
<xmlrequest>
<operation>SG</operation>
<authenticationKey>ssdf4jsdfg3</authenticationKey>
<earnerDetails>

<earnerID>0123456789</earnerID>
<earnerPW ssdf4jsdfg3</earnerPW>

</earnerDetails>
<groupID>0123456789</groupID>
<channelDetails>

<channel>2</channel>

<u sername>username@newmydomain.com</userName>
<channelPW>ssdf4jsdfg3</channelPW>

</channelDetails>

</xmlrequest>

Share group XML, response (SG) is provided by:

<xmlrequest>
<operation>SG</operation>
<earnerID>0123456789</earnerID>
<groupID>0123456789</groupID>
<channels>

<channelDetails>
<channel>1</channel>
<60sername>rbobby@company.com</userName>
<channelPW>ssdf4jsdfg3</channelPW>

</channelDetails>

<channelDetails>
<channel>2</channel>
<60sername>username@newmydomain.com</userName>
<channelPW>ssdf4jsdfg3</channelPW>

</channelDetails>

</channels>

</xmlrequest>
<xmlrequest>
<operation>SG</operation>
<earnerID>0123456789</earnerID>
<groupID>0123456789</groupID>
<channelDetails>

<channel>2</channel>

<60username>username@newmydomain.com</userName>
<channelPW>ssdf4jsdfg3</channelPW>

</channelDetails>

</xmlrequest>

TABLE 34
SG error codes

| Response | Purpose |
|---|---|
| A500 | Internal error occurred. Please contact an administrator. |
| A501 | Not all required information was supplied. |
| A502 | Operation not valid. |
| A503 | Incorrect authenticationKey. |
| A504 | earnerID not valid. |
| A505 | earnerEmail not valid. |
| A506 | Incorrect earnerPW |
| A507 | groupID not valid. |
| A508 | groupID not authorized to share. |
| A509 | Channel details not correct format. |
| A510 | Channel and userName already exists; previous values |
| | overwritten. |
| A510 | Expiration date invalid. |

An UnShare group (USG) as provided Groups are no longer available for viewing by applicable channels and userNames once unshared:

### Operation: UBG

### Direction: From Client to BC

URL: badgecert.com/api

### Method: HTTP POST

### Parameters: Table 35

Error codes: Table 36

TABLE 35
UBG parameters

| Field | Purpose | Field | Type | Example |
|---|---|---|---|---|
| earnerEmail | Email associated with | Optional | string | username@newmydomain.com |
| | earner | | | |
| earnerID | ID associated with | Optional | int | 0123456789 |
| | earner | | | |
| earnerPW | Earner account password | Required | string | ssdf4jsdfg3 |
| groupID | Earner group ID | Required | int | 0123456789 |
| channel | Channel with which | Required | Int | 1 - Email |
| | group is shared (check | | | 2 - LinkedIn ® |
| | for availability) | | | 3 - Facebook ® |
| userName | Email address or | Required | int | username@domain.com |
| | username | | | |
| channelPW | Password for email | Optional | int | Channel password |
| | channel | | | (except email) |
| dateUnShared | Date group shared | Required | time | 2013-05-24 14:00 |
| authentication | Unique Client passcode | Required | string | ssdf4jsdfg3 |
| Key | | | | |

Either earnerEmail or earnerID required.

UnShare group XML, request (USG) is provided by:

<xmlrequest>
<operation>UBG</operation>
<authenticationKey>ssdf4jsdfg3</authenticationKey>
<earnerDetails>

<earnerID>0123456789</earnerID>
<earnerPW ssdf4jsdfg3</earnerPW>

</earnerDetails>
<groupID>0123456789</groupID>
<channels>

<channelDetails>
<channel>1</channel>
<userName>rbobby@company.com</userName>
<channelPW>ssdf4jsdfg3</channelPW>

</channelDetails>

<channelDetails>
<channel>2</channel>
<userName>username@newmydomain.com</userName>
<channelPW>ssdf4jsdfg3</channelPW>

</channelDetails>

</channels>

</xmlrequest>

An UnShare group XML, response (USG) is provided by:

<xmlrequest>
<operation>UBG</operation>
<earnerID>0123456789</earnerID>
<groupID>0123456789</groupID>
<dateUnshared>2013-05-24 14:00</dateUnshared>
<channels>

<channelDetails>
<channel>1</channel>
<userName>rbobby@company.com</userName>
<channelPW>ssdf4jsdfg3</channelPW>

</channelDetails>

<channelDetails>
<channel>2</channel>
<userName>username@newmydomain.com</userName>
<channelPW>ssdf4jsdfg3</channelPW>

</channelDetails>

</channels>

</xmlrequest>

TABLE 36
UBG error codes

| Response | Purpose |
|---|---|
| A500 | Internal error occurred. Please contact an administrator. |
| A501 | Not all required information was supplied. |
| A502 | Operation not valid. |
| A503 | Incorrect authenticationKey. |
| A504 | earnerID not valid. |
| A505 | earnerEmail not valid. |
| A506 | Incorrect earnerPW |
| A507 | groupID not valid. |
| A508 | groupID not authorized to share. |
| A509 | Channel details not correct format. |
| A510 | Channels do not exist. |

A view earner groups (VEG) API flow is provided by:

### Operation: VEG

### Direction: From Client to BC

URL: badgecert.com/api

### Method: HTTP POST

### Parameters: Table 37

Error codes: Table 38

TABLE 37
VEG parameters

| Field | Purpose | Field | Type | Example |
|---|---|---|---|---|
| earnerEmail | Email associated with | Optional | string | username@newmydomain.com |
| | earner | | | |
| earnerID | ID associated with | Optional | int | 0123456789 |
| | earner | | | |
| earnerPW | Earner account password | Required | string | ssdf4jsdfg3 |
| groupID | Earner group ID | Required | int | 0123456789 |
| issueID | Issued badge ID | Required | int | 0123456789 |
| groupName | Name of badge group | Required | string | Home |
| groupIcon | Icon code for group | Optional | int | 2 |
| channel | Channel with which | Optional | Int | 1 - Email |
| | group is shared (check | | | 2 - LinkedIn ® |
| | for availability) | | | 3 - Facebook ® |
| userName | Email address or | Optional | int | username@domain.com |
| | username | | | |
| channelPW | Password for email | Optional | int | Channel password |
| | channel | | | (except email) |
| dateExpiration | Date sharing disabled | Optional | Int | 2013-05-24 14:00 |
| dateShared | Date group shared | Required | time | 2013-05-24 14:00 |
| authentication | Unique Client passcode | Required | string | ssdf4jsdfg3 |
| Key | | | | |

Either earnerEmail or earnerID required.

View earner groups XML request (VEG):

<xmlrequest>
<operation>VEG</operation>
<authenticationKey>ssdf4jsdfg3</authenticationKey>
<earnerDetails>

<earnerID>0123456789</earnerID>
<earnerPW ssdf4jsdfg3</earnerPW>

</earnerDetails>
</xmlrequest>

A notify groups XML, response (VEG):

<xmlrequest>
<operation>UBG</operation>
<earnerID>0123456789</earnerID>
<groups>

<groupDetails>
<groupID>0123456789<groupID>
<groupName>Home</groundName>
<groupIcon>2</groupIcon>

<dateAdded>2013-05-24 14:00<dateAdded>

<badges>

<badgeDetails>
<index>1</index>
<issueID>0123456789</issueID>

<dateAdded>2013-05-24 14:00<dateAdded>

</badgeDetails>
<badgeDetails>

<index>2</index>
< issueID >0123456789</issueID >

<dateAdded>2013-05-24 14:00<dateAdded>

</badgeDetails>
<badgeDetails>

<index>3</index>
< issueID >0123456789</issueID>

<dateAdded>2013-05-24 14:00<dateAdded>

</badgeDetails>

</badges>
<channels>
<channelDetails>
<channel>1</channel>
<userName>rbobby@company.com</userName>
<channelPW>ssdf4jsdfg3</channelPW>
<dateShared>2013-05-24 14:00<dateShared>
<dateExpiration>2013-05-24 14:00</dateExpiration>
</channelDetails>
<channelDetails>
<channel>2</channel>
<userName>username@newmydomain.com</userName>
<channelPW>ssdf4jsdfg3</channelPW>
<dateShared>2013-05-24 14:00<dateShared>
<dateExpiration>2013-05-24 14:00</dateExpiration>
</channelDetails>

</channels>

</groupDetails>
<groupDetails>
<groupID>0123456789<groupID>
<groupName>Work</groundName>
<groupIcon>3</groupIcon>

<dateAdded>2013-05-24 14:00<dateAdded>

<badges>

<badgeDetails>
<index>1</index>
<badgeID>0123456789</badgeID>

<dateAdded>2013-05-24 14:00<dateAdded>

</badgeDetails>
<badgeDetails>

<index>2</index>
<badgeID>0123456789</badgeID>

<dateAdded>2013-05-24 14:00<dateAdded>

</badgeDetails>
<badgeDetails>

<index>3</index>
<badgeID>0123456789</badgeID>

<dateAdded>2013-05-24 14:00<dateAdded>

</badgeDetails>

</badges>
<channels>
<channelDetails>
<channel>1</channel>
<userName>rbobby@company.com</userName>
<channelPW>ssdf4jsdfg3</channelPW>
<dateShared>2013-05-24 14:00<dateShared>
<dateExpiration>2013-05-24 14:00</dateExpiration>
</channelDetails>
<channelDetails>
<channel>2</channel>
<userName>username@newmydomain.com</userName>
<channelPW>ssdf4jsdfg3</channelPW>
<dateShared>2013-05-24 14:00<dateShared>
<dateExpiration>2013-05-24 14:00</dateExpiration>
</channelDetails>

</channels>

</groupDetails>
</groups>

</xmlrequest>

TABLE 38
VEG error codes

| Response | Purpose |
|---|---|
| A500 | Internal error occurred. Please contact an administrator. |
| A501 | Not all required information was supplied. |
| A502 | Operation not valid. |
| A503 | Incorrect authenticationKey. |
| A504 | earnerID not valid. |
| A505 | earnerEmail not valid. |
| A506 | Incorrect earnerPW |

In order to view the badge, the client performs the QB operation with the issueID parameter or visits the BC website to review the BADGECERT:

### Operation: NEB

### Direction: BC to Client

### URL: ClientURLNEB

### Method: HTTP POST

### Parameters: Table 39

TABLE 39

| Field | Purpose | Field | Type | Example |
|---|---|---|---|---|
| issueID | Email associated with | Required | int | 0123456789 |
| | earner | | | |
| issueType | Type of badge issued | Required | Int | 1 - standard |
| | | | | BADGECERT |
| | | | | 2 - endorsement |
| | | | | BADGECERT |
| earnerID | ID associated with | Required | int | 0123456789 |
| | earner | | | |

A Notify earner of BADGECERT XML response (NEB) is provided by:

<xmlresponse>
<operation>NEB</operation>
<issueID>0123456789</issueID>
<issueType>1</issueType>
<earnerID>0123456789</earnerID>
</xmlresponse>

An earner accept/decline new BADGECERT (EAB) API flow is provided by:

### Operation: EAB

### Direction: From Client to BC

URL: badgecert.com/api

### Method: HTTP POST

### Parameters: Table 40

Error codes: Table 41

TABLE 40
EAB parameters

| Field | Purpose | Field | Type | Example |
|---|---|---|---|---|
| earnerEmail | Email associated with | Optional | string | username@newmydomain.com |
| | earner | | | |
| earnerID | ID associated with | Optional | int | 0123456789 |
| | earner | | | |
| earnerPW | Earner account password | Required | string | ssdf4jsdfg3 |
| issueID | Issued badge ID | Required | int | 0123456789 |
| earnerAcceptance | Indication whether | Required | int | 1 - Accept |
| | earner accepts | | | 2 - Decline |
| | BADGECERT | | | |
| dateAccepted | Date BADGECERT | Required | time | 2013-05-24 14:00 |
| | accepted or declined | | | |
| authentication | Unique Client passcode | Required | string | ssdf4jsdfg3 |
| Key | | | | |

An earner accept BADGECERT request (EAB) is provided by:

<xmlrequest>
<operation>EAB</operation>
<authenticationKey>ssdf4jsdfg3</authenticationKey>
<earnerDetails>

<earnerID>0123456789</earnerID>
<earnerPW ssdf4jsdfg3</earnerPW>

</earnerDetails>
<badgeDetails>

<issueID>0123456789</issueID>
<earnerAcceptance>1<earnerAcceptance>

</badgeDetails>
</xmlrequest>

An earner accept BADGECERT response (EAB) is provided by:

<xmlrequest>
<operation>EAB</operation>
<earnerID>0123456789</earnerID>
<badgeDetails>

<issueID>0123456789</issueID>
<earnerAcceptance>1<earnerAcceptance>
<dateAccepted>2013-05-24 14:00</dateAccepted>

</badgeDetails>
</xmlrequest>

TABLE 41
EAB error codes

| Response | Purpose |
|---|---|
| A500 | Internal error occurred. Please contact an administrator. |
| A501 | Not all required information was supplied. |
| A502 | Operation not valid. |
| A503 | Incorrect authenticationKey. |
| A504 | earnerID not valid. |
| A505 | earnerEmail not valid. |
| A506 | Incorrect earnerPW |
| A507 | issueID not valid. |
| A508 | issueID already accepted. |
| A509 | issueID already declined. |
| A510 | earnerAcceptance parameter not valid. |

An earner issue endorsement (EIE) provides for notification of a recipient earner when an endorsement BADGECERT. A BADGECERT endorsement is both created and issued by an earner. Once created, an endorsement is issued to an earner and the earner is notified of the endorsement. An EIE is described by:

### Operation: EIE

### Direction: From Client to BC

URL: badgecert.com/api

### Method: HTTP POST

### Parameters: Table 42

Error codes: Table 43

TABLE 42
EIE parameters

| Field | Purpose | Field | Type | Example |
|---|---|---|---|---|
| earnerEmail | Email associated with | Optional | string | username@newmydomain.com |
| | earner | | | |
| earnerID | ID associated with earner | Optional | int | 0123456789 |
| earnerPW | Earner account password | Required | string | ssdf4jsdfg3 |
| recipientEmail | Email associated with | Required | string | username@newmydomain.com |
| | recipient earner | | | |
| issueID | ID associated with | Required | int | 0123456789 |
| | endorsement | | | |
| issuerName | Name issuer would like to | Optional | String | Fred at House Works |
| | use | | | |
| iconID | URL of JPEG image | Optional | string | http://yoursite.com/abc01234.jpg |
| | associated with | | | |
| | endorsement icon | | | |
| ringColor | Color of badge outer ring | Required | string | red, blue, purple, gold, grey |
| endorsementTitle | Title displayed on | Required | string | Excellent software coding |
| | endorsement (50 | | | |
| | characters) | | | |
| endorsementLong | Long description | Optional | memo | I've worked with hundreds of |
| Desc | describing endorsement | | | software developers over the |
| | (500 characters) | | | years and David is among the |
| | | | | finest in writing and |
| | | | | compiling clean Java code. |
| | | | | He has written numerous |
| | | | | eCommerce applications |
| | | | | involving complex banking |
| | | | | transactions. |
| eventDate | Date/time underlying | Optional | time | 2013-05-24 14:00 |
| | event occurred | | | |
| expirationDate | Date/time endorsement | Optional | time | 2013-05-24 14:00 |
| | expires | | | |
| issueDate | Date/time endorsement | Required | time | 2013-05-24 14:00 |
| | created by BC | | | |
| issueNotes | Data associated with | Optional | NVP | See FIG. 34 |
| | endorsement | | | |
| artifact1PDF | Location of 1st PDF | Optional | string | http://yoursite.com/abc01234.pdf |
| | artifact file | | | |
| artifact2PDF | Location of 2nd PDF | Optional | string | http://yoursite.com/abc01234.pdf |
| | artifact file | | | |
| artifact1Web | URL of 1st artifact | Optional | string | http://dropbox.com/0123456789 |
| | (reference only) | | | |
| artifact2Web | URL of 2nd artifact | Optional | string | http://dropbox.com/0123456789 |
| | (reference only) | | | |
| authentication | Unique Client passcode | Required | string | ssdf4jsdfg3 |
| Key | | | | |

An earner issue endorsement request (EIE) is provided by:

<xmlrequest>
<operation>EIE</operation>
<<earnerDetails>

<earnerID>0123456789</earnerID>
<earnerPW ssdf4jsdfg3</earnerPW>

</earnerDetails>
<recipientEmail>username@newmydomain.com</recipientEmail>
<authenticationKey>ssdf4jsdfg3 </authenticationKey>
<badgeTitle>Excellent software coding</badgeTitle>
<iconID>http://yoursite.com/abc01234.jpg</iconID>
<ringColor>purple</ringColor>
<issuerName>Fred at House Works</issuerName>
< badgeLongDesc></badgeLongDesc>
<eventDate>2013-05-24 14:00</eventDate>
<expirationDate>2013-05-24 14:00<expirationDate>
<artifact1PDF>http://yoursite.com/abc01234.pdf</artifact1PDF>
<artifact2PDF>http://yoursite.com/abc01234.pdf</artifact2PDF>
<artifact1Web>http://dropbox.com/0123456789</artifact1Web>
<artifact2Web>http://dropbox.com/0123456789</artifact2Web>
<issueNotes>

<note>
<name>startDate</name>
<value>2011-05-06 11:28</value>
</note>
<note>
<name>endDate</name>
<value>2011-05-06 11:28</value>
<note>
<note>
<name>Software applications</name>
<value>15</value>
<note>

</issueNotes >
</xmlrequest>

An earner issue endorsement response (EIE) is provided by:

<xmlresponse>
<operation>EIE</operation>
<earnerID>0123456789</earnerID>
<recipientEmail>username@newmydomain.com</recipientEmail>
<issueDate><eventDate>2013-05-24 14:00</issueDate>
<issueID>0123456789</issueID>
<badgeTitle>Excellent software coding</badgeTitle>
<iconID>http://yoursite.com/abc01234.jpg</iconID>
<ringColor>purple</ringColor>
<issuerName>Fred at House Works</issuerName>
< badgeLongDesc> I've worked with hundreds of software developers
over the years and David is among the finest in writing and compiling
clean Java code. He has written numerous eCommerce applications
involving complex banking transactions.</badgeLongDesc>
<eventDate>2013-05-24 14:00</eventDate>
<expirationDate>2013-05-24 14:00<expirationDate>
<artifact1PDF>http://yoursite.com/abc01234.pdf</artifact1PDF>
<artifact2PDF>http://yoursite.com/abc01234.pdf</artifact2PDF>
<artifact1Web>http://dropbox.com/0123456789</artifact1Web>
<artifact2Web>http://dropbox.com/0123456789</artifact2Web>
<issueNotes>

<note>
<name>startDate</name>
<value>2011-05-06 11:28</value>
</note>
<note>
<name>endDate</name>
<value>2011-05-06 11:28</value>
<note>
<note>
<name>Software applications</name>
<value>15</value>
<note>

</issueNotes >
</xmlresponse >

TABLE 43
EIE error codes are:

| Response | Purpose |
|---|---|
| A500 | Internal error occurred. Please contact an administrator. |
| A501 | Not all required information was supplied. |
| A502 | Operation not valid. |
| A503 | earnerID not valid. |
| A504 | earnerEmail not valid. |
| A505 | Incorrect earnerPW |
| A506 | Incorrect authenticationKey. |
| A507 | recipientEmail not found; email invitation sent |
| A508 | iconID invalid. |
| A509 | ringColor invalid. |
| A510 | endorsementTitle must be valid and =<50 characters. |
| A511 | endorsementLongDesc must be valid and =<500 |
| | characters. |
| A512 | issueNotes not correct format. |
| A513 | eventDate not correct format. |
| A514 | expirationDate not correct format. |
| A515 | issueNotes not correct format. |
| A516 | artifactPDF not correct format. |
| A517 | artifactWeb not correct format. |
| A518 | issuerName not correct format. |

An earner self-issue badge (ESB) API flow enables a self-issued BADGECERT that is both created and issued by an earner. There is no earner notification that he/she has self-issued a BADGECERT.

### Operation: ESB

### Direction: From Client to BC

URL: badgecert.com/api

### Method: HTTP POST

### Parameters: Table 44

Error codes: Table 45

TABLE 44
ESB parameters

| Field | Purpose | Field | Type | Example |
|---|---|---|---|---|
| earnerEmail | Email associated with | Optional | string | username@newmydomain.com |
| | earner | | | |
| earnerID | ID associated with earner | Optional | int | 0123456789 |
| earnerPW | Earner account password | Required | string | ssdf4jsdfg3 |
| recipientEmail | Email associated with | Required | string | username@newmydomain.com |
| | recipient earner | | | |
| issueID | ID associated with self- | Required | int | 0123456789 |
| | issue BADGECERT | | | |
| iconID | URL of JPEG image | Optional | string | http://yoursite.com/abc01234.jpg |
| | associated with self-issue | | | |
| | BADGECERT icon | | | |
| ringColor | Color of badge outer ring | Required | string | red, blue, purple, gold, grey |
| badgeTitle | Title displayed on self- | Required | string | Excellent software coding |
| | issue BADGECERT (50 | | | |
| | characters) | | | |
| badgeLongDesc | Long description | Optional | memo | I've worked with hundreds of |
| | describing self-issue | | | software developers over the |
| | BADGECERT (500 | | | years and David is among the |
| | characters) | | | finest in writing and |
| | | | | compiling clean Java code. |
| | | | | He has written numerous |
| | | | | eCommerce applications |
| | | | | involving complex banking |
| | | | | transactions. |
| issueDate | Date/time endorsement | Required | time | 2013-05-24 14:00 |
| | created by BC | | | |
| artifact1PDF | Location of 1st PDF | Optional | string | http://yoursite.com/abc01234.pdf |
| | artifact file | | | |
| artifact2PDF | Location of 2nd PDF | Optional | string | http://yoursite.com/abc01234.pdf |
| | artifact file | | | |
| artifact1Web | URL of 1st artifact | Optional | string | http://dropbox.com/0123456789 |
| | (reference only) | | | |
| artifact2Web | URL of 2nd artifact | Optional | string | http://dropbox.com/0123456789 |
| | (reference only) | | | |
| authentication | Unique Client passcode | Required | string | ssdf4jsdfg3 |
| Key | | | | |

An earner self-issue BADGECERT request (ESB) is provided by:

<xmlrequest>
<operation>ESB</operation>
<<earnerDetails>

<earnerID>0123456789</earnerID>
<earnerPW ssdf4jsdfg3</earnerPW>

</earnerDetails>
<authenticationKey>ssdf4jsdfg3 </authenticationKey>
<badgeTitle>New Java software module</badgeTitle>
<iconID>http://yoursite.com/abc01234.jpg</iconID>
<ringColor>purple</ringColor>
< badgeLongDesc> I wrote a complex Java application that leveraged jQuery frontend
and interface to numerous social networking applications .</badgeLongDesc>
<artifact1PDF>http://yoursite.com/abc01234.pdf</artifact1PDF>
<artifact2PDF>http://yoursite.com/abc01234.pdf</artifact2PDF>
<artifact1Web>http://dropbox.com/0123456789</artifact1Web>
<artifact2Web>http://dropbox.com/0123456789</artifact2Web>
</xmlrequest>

Earner self-issue BADGECERT response (ESB) is provided by:

<xmlresponse>
<operation>ESB</operation>
<<earnerDetails>

<earnerID>0123456789</earnerID>

</earnerDetails>
<issueID>0123456789<issueID>
<badgeTitle>New Java software module</badgeTitle>
<iconID>http://yoursite.com/abc01234.jpg</iconID>
<ringColor>purple</ringColor>
< badgeLongDesc> I wrote a complex Java application that leveraged jQuery frontend
and interface to numerous social networking applications .</badgeLongDesc>
<artifact1PDF>http://yoursite.com/abc01234.pdf</artifact1PDF>
<artifact2PDF>http://yoursite.com/abc01234.pdf</artifact2PDF>
<artifact1Web>http://dropbox.com/0123456789</artifact1Web>
<artifact2Web>http://dropbox.com/0123456789</artifact2Web>
</xmlresponse>

TABLE 45
ESB error codes

| Response | Purpose |
|---|---|
| A500 | Internal error occurred. Please contact an administrator. |
| A501 | Not all required information was supplied. |
| A502 | Operation not valid. |
| A503 | earnerID not valid. |
| A504 | earnerEmail not valid. |
| A505 | Incorrect earnerPW |
| A506 | Incorrect authenticationKey. |
| A507 | iconID invalid. |
| A508 | ringColor invalid. |
| A509 | badgeTitle must be valid and =<50 characters. |
| A510 | badgeLongDesc must be valid and =<500 characters. |
| A511 | artifactPDF not correct format. |
| A512 | artifactWeb not correct format. |

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for displaying digital badge information, the badge corresponding to a digital image being presented to a user of a computer application and associated with an individual or entity badge owner to whom the badge is issued, comprising;
displaying the digital image to the user;
receiving input indicating that the user has selected the digital image;
obtaining, from a data repository, information pertaining to the image and particular to an accomplishment of the badge owner; and displaying at least a subset of the obtained information on an overlay to the image

2.The method of claim 1, wherein the obtained information comprises data from a customized set of data fields.

3. The method of claim 1, wherein the displayed information includes the name of the badge owner.

4 The method of claim 1, further comprising:
combining data for a first digital badge of the badge owner with data for a second digital badge of the badge owner to form the digital badge corresponding to the digital image being presented.

5. The method of claim 4 further comprising:
receiving an indication that the badge owner has succeeded in a sequence of accomplishments corresponding a sequence of digital badges; and
combining data for each of a sequence of digital badges of the badge ow ner to form the digital badge corresponding to the digital image being presented

6. The method of claim 5, wherein each badge in the sequence of badges has an associated point value, and the digital badge corresponding to the digital image being presented has a point value that is the sum of the point values for badges in the sequence

7. The method of claim 1, further comprising calculating a badge score for the digital badge corresponding to the digital image being presented, wherein the badge score is based on the number of times the badge has been opened, shared, or viewed.

8 The method of claim 1, further comprising:
providing a custom QR code to the badge owner at the time of the accomplishment;
receiving an indication that the custom QR code has been accessed, and
adding the information particular to the accomplishment for the badge owner to the data repository.

9.The method of claim 1, further comprising:
receiving, from the badge owner, information regarding the accomplishment;
wherein the displayed information indicates that the badge is self-reported.

10. The method of claim 9, further comprising:
receiving, from the badge owner, the identity of an endorser for the self-reported badge;
transmitting an endorsement request to the endorser, including information pertaining to the badge owner and the accomplishment;
receiving, from the endorser, an endorsement in response to the request; and
adding the endorsement to the information in the data repository corresponding to the badge;
wherein the displayed information indicates that the self-reported badge is endorsed.

11. A system for providing data contained in a digital badge data structure to a user of a computer application, the data including data corresponding to a digital image, the system comprising:
core engine means, including one or more processors, for creating the digital badge data structure;
processor readable storage media configured to store the digital badge data structure and the data corresponding to the digital image;
issuer gateway means for receiving instructions from an issuer, and for creating the digital badge data structure; and
earner gateway means for providing, to an earner, a notification of the creation of the digital badge data structure and a reference to a location at which the digital badge data structure is located.

12. The system of claim 11, wherein the core engine means comprises:
means for receiving the instructions for creating the digital badge data structure, wherein the instructions specify one or more data fields to be included in the digital badge data structure and a value for each of the one or more data fields; and
means for creating the digital badge structure according to the one or more specified data fields and the specified values for each of the one or more data fields.

13. The system of claim 12, wherein creating the digital badge structure further comprises:
determining an identity of the issuer;
identifying one or more permissions allocated to the issuer;
determining one or more permissions required for providing the instructions received from the issuer;
determining that the permissions required for providing the instructions received from the issuer are allocated to the issuer.

14. The system of claim 13, core engine means further for comparing an identity of the issuer with a value for an earner identity field and to execute a self-issuer procedure if the identify of the issuer corresponds to the value for the earner identity field.

15. The system of claim 12, wherein the instructions include an endorsement request and an endorser identification.

16. The system of claim 15, wherein creating the digital badge structure further comprises:
searching for the endorser identification within a list of authorized endorsers;
transmitting a notification to the endorser corresponding to the endorser identification included in the instructions if the endorser identification is found within the list of authorized endorsers; and
alerting the issuer that the endorser identification was not found within the list of authorized endorsers otherwise.

17. The system of claim 11, core engine means further for receiving an acceptance from the earner.

18. The system of claim 17, wherein the acceptance from the earner specifies one or more privacy settings corresponding to the digital badge data structure.

19. The system of claim 18, the core engine means further for establishing validation procedures required to access the location at which the digital badge data structure is located.

20. The system of claim 19, the core engine means further for receiving, from client device, a request to access the location at which the digital badge data structure is located; and
to execute a validation procedure to determine if the privacy settings forbid the client device from accessing the location at which the digital badge data structure is located.
